(19) United States
(12) Patent Application Publication
(10) Pub. No.: US 2007/0195756 A1
(43) Pub. Date: Aug. 23, 2007

(54) Terminal switching technology for seamless switching of streaming sessions between terminals

(75) Inventors: Daisaku Komiya, Kanagawa (JP); Eunsoo Shim, San Jose, CA (US); Mingqiang Xu, Chiba (JP); Sachiko Takeshita, Tokyo (JP)

Correspondence Address: GREENBLUM & BERNSTEIN, P.L.C., 1950 ROLAND CLARKE PLACE, RESTON, VA, 20191, US

(73) Assignee: Matsushita Electric Industrial Co., Ltd., Osaka (JP)

(21) Appl. No.: 11/359,477

(22) Filed: Feb. 23, 2006

(51) Int. Cl. H04L 12/50

(52) U.S. Cl. 370/362

(57) ABSTRACT

Terminal switching technology for seamlessly switching streaming sessions between terminals is provided. In this technology, a switching destination terminal has an establishing section establishing a streaming session with a communicating party according to a terminal switching request, a receiving section receiving data from the communicating party after a streaming session is established with the communicating party, a storing section storing received data, and an acquisition section acquiring newest data from the terminal apparatus of the switching source transmitting the terminal switching request in the event that the newest data to be outputted is not in the storing section after the terminal switching request is received and the storing section starts storing the data.

### BACKGROUND OF THE INVENTION

1. Field of the Invention

The present invention relates to communication technology and media transmission/buffer control technology for an IP (Internet Protocol) network, and more specifically relates to terminal switching technology for seamless switching of streaming sessions between terminals.

2. Related Art

In recent years, in addition to optical fiber and ADSL (asymmetric digital subscriber line) occurring in fixed networks, wireless technology applicable to spots such as WLAN (wireless local area network) and ad-hoc networks have also become widespread for mobile networks. This has brought about implementation of a ubiquitous network environment where it is possible to connect to a network at all kinds of places. Further, devices having a wide variety of capabilities typified by dual terminals with networked appliances and public locations have also been disclosed in the field of communication terminals. Here, it is preferable to implement seamless services capable of carrying out continuous services by freely switching between a variety of accessible networks of the ubiquitous network environment and between devices having a wide variety of capabilities.

Three seamless technologies have been proposed as technologies for implementing seamless services.

The first, referred to as “network seamless,” makes it possible to seamlessly switch to different networks and continue communication as a single mobile terminal moves etc. A mobile terminal has a plurality of network interfaces and is capable of freely switching access networks according to movement. Network seamless may also be referred to as “terminal mobility.”

The second, referred to as “device seamless,” makes it possible to seamlessly switch terminals while being used by the user. This enables a session being used by a certain terminal to continue to be used by other terminal. This is also referred to as “session mobility” as a session is moved to other terminals.

The third, referred to as “content seamless,” makes it possible to seamlessly switch media formats and media types, etc. Content seamless is capable of switching and displaying/playing media according to network bandwidth, device performance, and the surrounding environment, etc. Further, content seamless can be referred to as “media adaptive.”

These three technologies are extremely important in implementing seamless services, but, since independent results are obtained, the technologies may be implemented independently or in combinations of a plurality.

The following conditions can be considered as seamless services (hereinafter referred to as “terminal switching”) to which device seamless technology can be applied. A user returning home while watching a streaming movie using a mobile terminal such as a mobile telephone can instantaneously switch use of the display to a large-scale television upon entering his own living room, and watch the rest of the movie.

Typically, the display of the mobile terminal is small and it cannot be said to be preferable to watch a movie. In the event of finding an optimum device capable of enjoying continued service around according to movement etc., if it is possible to switch the terminals, the convenience of user becomes extremely high.

Further, it is preferable for the terminal switching to be carried out seamlessly. When the time required for terminal switching is long, in the event of watching a soccer match in real time, there may be situations where an important moment such as a goal is missed as a result of terminal switching.

Seamless terminal switching will be described using FIG.1. FIG. 1 shows the relationship between the numbers of data and the times outputted at a switching source terminal and a switching destination terminal taking the time axis direction as being downwards.

In FIG. 1, the switching source terminal outputs from data 3 to data 7 in order, and the switching destination terminal starts output from data 9. Assume that the time a user outputs a switching instruction to the switching source terminal is Tc, the time of stopping output of data at the switching source terminal is Ts, and the time of starting output of data at the switching destination terminal is Td.

Td-Ts that is the time from stopping of data output at the switching source terminal to the starting of data output at the switching destination terminal is referred to as a “time gap.” When a time gap occurs, this means that continuous output of the data is interrupted.

Further, the difference between the data number outputted at the switching destination terminal at time Td and the data number outputted at the switching source terminal at time Ts is referred to as “media gap.” In this example, 9−7−1=1. In the event that the media gap is a positive value, this means that loss occurs in outputted data, and in the event of a negative value, this means that redundancy occurs in the outputted data.

Td-Tc that is the time from receiving a switching instruction from the user at a switching source terminal to starting data output at a switching destination terminal is referred to as “response delay.” Response delay is the switching terminal waiting time perceived by the user, and when the response delay is large even if a time gap is 0 and a media gap is 0, this cannot be said to be seamless terminal switching.

From the above description, seamless terminal switching is implemented with the time gap, media gap and response delay all sufficiently small.

Non-patent document 1: (R. Shacham, et al. “Session Initiation Protocol Session Mobility” IETF Internet-Draft, Jul. 6, 2005) discloses the following terminal switching method.

FIG. 2 shows a system configuration view of a typical terminal switching system. The terminal switching system of FIG. 2 is configured with switching source terminal 10, corresponding destination node (hereinafter referred to as “CN (Correspondent Node)”) 20 that is a communicating party, network 30 such as the Internet, and switching destination terminal 40 that is a terminal switching target. The terminal switching method disclosed in non-patent document 1 can be used with the above configuration in switching sessions between switching source terminal 10 and CN 20 to sessions between switching destination terminal 40 and CN 20.

FIG. 3 is a view showing a configuration of switching destination terminal 40. Switching destination terminal 40 in FIG. 3 has signaling section 42 for carrying out session control (i.e. control of establishment and ending etc. of sessions) between switching source terminal 10 and CN 20, data receiving section 44 receiving data transmitted by CN 20, media buffer 46 storing received data, decoder 48 decoding the received data, and output section 50 outputting data decoded by decoder 48.

In the terminal switching method of non-patent document 1, when switching source terminal 10 receives a terminal switching request from a user, a terminal switching notification is transmitted to switching destination terminal 40. This notification is carried out by an SIP “REFER” message. SIP is “Session Initiation Protocol” and is a session control protocol standardized by the IETF (Internet Engineering Task Force) Details are disclosed in RFC3261.

Signaling section 42 of switching destination terminal 40 receiving the “REFER” message acquires information of CN 20 from the message header, and transmits to CN 20 an SIP “INVITE” message for establishing a session with CN 20. Signaling section 42 of switching destination terminal 40 then completes the procedure for establishing a session between switching destination terminal 40 and CN 20 by receiving a response to the “INVITE” message from CN 20. After this, signaling section 42 of switching destination terminal 40 transmits a response to the “REFER” message to switching source terminal 10. It is possible to transmit and receive media between switching destination terminal 40 and CN 20 by establishing the session.

Data transmitted from CN 20 is received by data receiving section 44 of switching destination terminal 40 and prebuffered in media buffer 46. “Prebuffering” refers to buffering carried out in order to make up for the influence of network jitter on data played back at a terminal. Normally, after prebuffering data for from a few seconds to a few tens of seconds, data playback is started. After prebuffering is complete, switching destination terminal 40 starts decoder 48. After acquiring data prebuffered in media buffer 46 in order and decoding this data, the data is outputted to output section 50.

After a fixed period of time has passed since switching source terminal 10 received a “REFER” message, or after a fixed period of time has passed since CN 20 sent a response to the “INVITE” message, the session between switching source terminal 10 and CN 20 is ended by one of either switching source terminal 10 or CN 20 transmitting a “BYE” message to the other, and session switching is complete.

Japanese Patent Application Laid-Open No. 2005-27314 (hereinafter referred to as “patent document 1”) discloses terminal mobility technology capable of seamlessly switching to a different network while a mobile terminal continues to communicate in accompaniment with movement etc. More specifically, it is an object of patent document 1 to provide a handover method capable of reducing handover disruption time, packet loss rate and home agent load respectively when a mobile terminal moves (L3 handover) across subnets (access routers).

According to this method, a mobile terminal monitors link conditions using an access terminal and starts handover. After this, a mobile terminal transmits link information of the new access router to the current access router.

In response to an inquiry of the current access router, the new access router returns network information of the router, and starts network layer handover prior to link layer handover. The data transmitted from CN is then transmitted directly to a new care of address of the mobile terminal.

A mobile terminal cannot transmit and receive data during link layer handover, and therefore packet loss occurs. In order to reduce packet loss, the packets during disruption of the link layer connection are transmitted from the current access router to the new access router. Prior to establishing a link layer connection, the new access router stores data in the extended cache module. After connection, the new access router transfers the stored data to a mobile terminal.

However, in the method of non-patent document 1, it is possible to implement terminal switching, but in implementation of terminal switching, time gaps, media gaps and response delays occur, and it is therefore not possible to implement seamless terminal switching. The reason is that, session mobility of streaming applications requiring prebuffering requires time for prebuffering data in the media buffer of switching destination terminal 40 before switching destination terminal 40 outputs data.

Further, patent document 1 discloses technology for switching to a different network as the mobile terminal moves, but does not disclose a mechanism for switching seamlessly to a different terminal.

Further, patent document 1 discloses a method for caching data for implementing seamless switching and fixed results can be seen for packet loss. However, the cache performs temporary caching regard less of redundancy and loss with respect to data before connection of the mobile terminal and the new access router, and is therefore insufficient to completely resolve the media gap. Further, unless the size of the cache is set sufficiently large, it is not possible to handle the case where extension cache modules of new access routers overflow.

### SUMMARY OF THE INVENTION

It is therefore an object of the present invention to provide a terminal switching system capable of seamlessly switching a streaming session between terminals, terminal apparatus used in this system, a terminal switching method, and a recording medium recording a terminal switching program.

According to one aspect of the present invention, terminal apparatus has an establishing section establishing a streaming session with a communicating party according to a terminal switching request, a receiving section receiving data from the communicating party after a streaming session is established with the communicating party, a storing section storing received data, and an acquisition section acquiring newest data from the terminal apparatus of the switching source transmitting the terminal switching request in the event that the newest data to be outputted is not in the storing section after the terminal switching request is received and the storing section starts to store the data.

According to another aspect of the present invention, a terminal switching method has the steps of establishing a streaming session with a communicating party according to a terminal switching request, receiving data from the communicating party after a streaming session is established with the communicating party, storing the received data in the storing section, and acquiring newest data from the terminal apparatus of the switching source transmitting the terminal switching request in the event that newest data to be outputted is not in the storing section after the terminal switching request is received and the storing section starts to store the data.

According to further aspect of the present invention, the terminal apparatus has an establishing section establishing a streaming session with other terminal apparatus that is a target of a terminal switching request, a receiving section receiving data from the other terminal apparatus after a streaming session is established with the other terminal apparatus, a storing section storing received data, and a transmission section transmitting data corresponding to a newest data acquisition request from data stored in the storing section to the other terminal apparatus according to the newest data acquisition request from the other terminal apparatus.

According to a still further aspect of the present invention, a terminal switching method has the steps of establishing a streaming session with other terminal apparatus that is a target of a terminal switching request, receiving data from the other terminal apparatus after a streaming session is established with the other terminal apparatus, storing the received data in the storing section, and transmitting data corresponding to a newest data acquisition request from data stored in the storing section to the other terminal apparatus according to the newest data acquisition request from the other terminal apparatus.

According to a yet further aspect of the present invention, a terminal switching system has a switching destination terminal apparatus and a switching source terminal apparatus, and the switching destination terminal apparatus has a first establishing section establishing a streaming session with a communicating party according to a terminal switching request transmitted by the switching source terminal apparatus, a first receiving section receiving data from the communicating party after a streaming session is established with the communicating party, a first storing section storing data received by the first receiving section, and an acquisition section acquiring the newest data from the switching source terminal apparatus in the event that newest data to be outputted is not in the first storing section after the terminal switching request is received and the first storing section starts to store the data, and the switching destination terminal apparatus has a second establishing section establishing a streaming session with the switching destination terminal apparatus, a second receiving section receiving data from the switching destination terminal apparatus after a streaming session is established with the switching destination terminal apparatus, a second storing section storing data received by the second receiving section, and a second transmission section transmitting data corresponding to a newest data acquisition request from data stored in the second storing section to the switching destination terminal apparatus according to the newest data acquisition request from the switching destination terminal apparatus.

### BRIEF DESCRIPTION OF THE DRAWINGS

The above and other objects and features of the invention will appear more fully hereinafter from a consideration of the following description taken in connection with the accompanying drawings wherein examples are illustrated, in which:

FIG. 1 is a view for illustrating seamless terminal switching;

FIG. 2 is a configuration view showing an example of a terminal switching system of the related art;

FIG. 3 is a block diagram showing an example of a configuration of a switching destination terminal of the terminal switching system of FIG. 2;

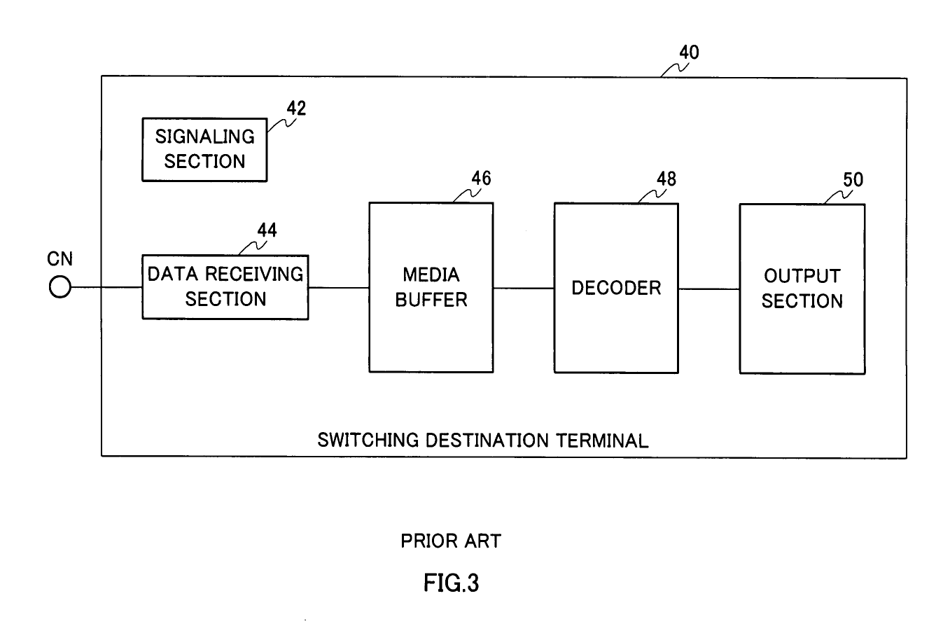

FIG. 4 is a system configuration view of a terminal switching system according to embodiment 1 of the present invention;

FIG. 5 is a block diagram showing an example configuration of a switching destination terminal of a terminal switching system of FIG. 4;

FIG. 6 is a block diagram showing an example of a media synchronization control section of the switching destination terminal of FIG. 5;

FIG. 7 is a view illustrating assumptions shared by terminal switching technology in general;

FIG. 8 is a flowchart showing an example of switching destination terminal operation of FIG. 5;

FIG. 9A is a view illustrating a certain instant occurring in the operation of the terminal switching system of FIG. 4;

FIG. 9B is a view illustrating a further instant occurring in the operation of the terminal switching system of FIG. 4;

FIG. 10 is a view showing a comparison of results relating to switching of the terminal switching system of FIG. 2 and results relating to switching of the terminal switching system of FIG. 4;

FIG. 11 is a block diagram showing a configuration of a switching source terminal of a terminal switching system of FIG. 4;

FIG. 12 is a flowchart showing an example of an operation of a switching source terminal of FIG. 11;

FIG. 13 is a sequence view showing the exchange of messages between a switching source terminal, switching destination terminal, and third party CN of the terminal switching system of FIG. 4;

FIG. 14 is a flowchart showing an example of an operation of a switching destination terminal of a terminal switching system according to embodiment 2 of the present invention;

FIG. 15 is a graph showing the change in data stored in the media buffer of a switching source terminal and the media buffer of a switching destination terminal with time for a first aspect of embodiment 2;

FIG. 16 is a graph showing the change in data stored in the media buffer of a switching source terminal and the media buffer of a switching destination terminal with time for a second aspect of embodiment 2;

FIG. 17 is a system configuration view of a terminal switching system according to embodiment 3 of the present invention;

FIG. 18 is a block diagram showing an example configuration of a switching destination terminal of a terminal switching system of FIG. 17;

FIG. 19 is a block diagram showing an example of a media synchronization control section of FIG. 18; and

FIG. 20 is a flow chart showing an example of switching destination terminal operation of FIG. 18.

### DETAILED DESCRIPTION OF PREFERRED EMBODIMENTS

Embodiments of the present invention will be explained below in detail with reference to the accompanying drawings.

### Embodiment 1

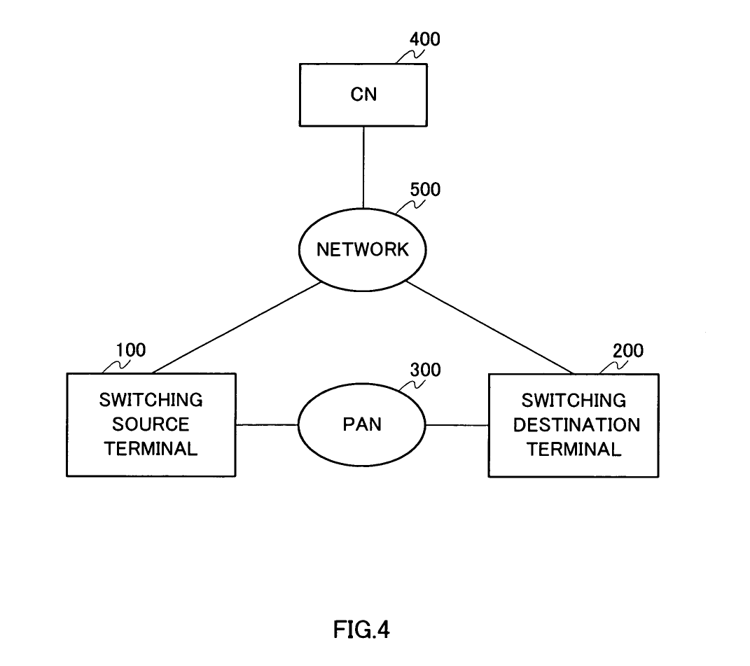

FIG. 4 shows a system configuration of a terminal switching system according to embodiment 1 of the present invention.

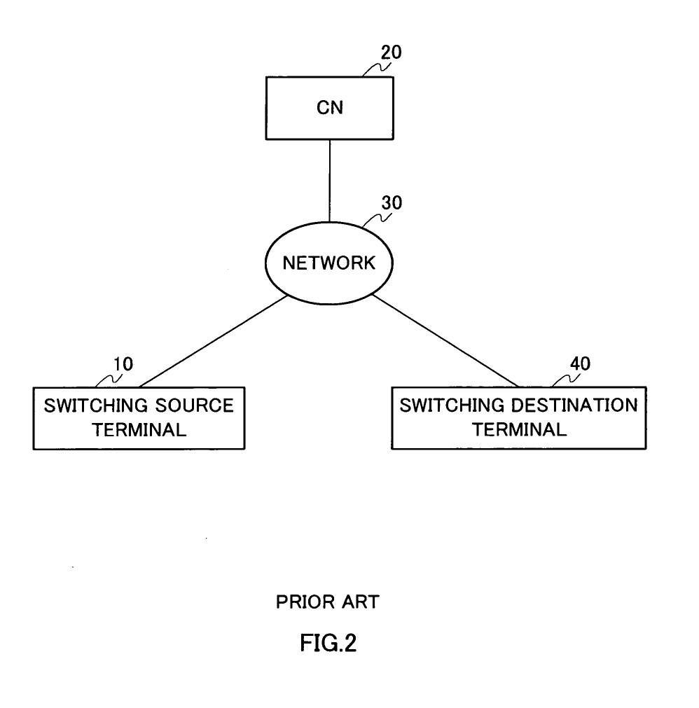

Compared to the terminal switching system of the related art of FIG. 2, the terminal switching system of FIG. 4 is capable of seamlessly switching streaming sessions between terminals. Switching source terminal 100 and switching destination terminal 200 of the present invention have a characteristic internal configuration and operation to implement seamless terminal switching from switching source terminal 100 to switching destination terminal 200.

Namely, more specifically, the terminal holding a session with the communicating party has a configuration and operation for ensuring continuity of media data outputted to the switching source terminal by the switching destination terminal without increasing the response delay in switching to other terminal while maintaining the session.

Further, in view of the physical positional relationship of switching source terminal 100 and switching destination terminal 200, PAN (Personal Area Network) 300 such as UWB (Ultra Wide Band) or Bluetooth (registered trademark) etc. can be used as a network between switching source terminal 100 and switching destination terminal 200.

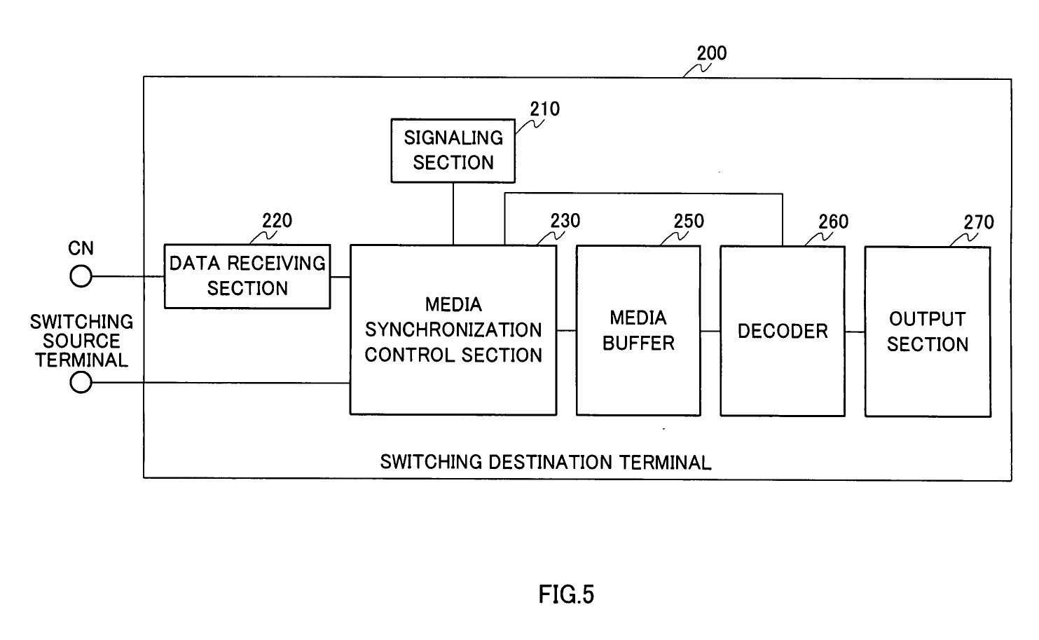

FIG. 5 is a block diagram showing an internal configuration of switching destination terminal 200 of this embodiment.

Switching destination terminal 200 has signaling section 210 for carrying out session control (i.e. control of establishment and termination etc. of sessions) between switching source terminal 100 and CN 400, data receiving section 220 receiving data transmitted from CN 400, media synchronization control section 230 controlling storage of the received data in media buffer 250, media buffer 250 storing the received data, decoder 260 decoding the received data, and output section 270 outputting the data decoded by the decoder.

In the above configuration, media synchronization control section 230 and signaling section 210 are structural elements different from the technology of the related art.

First, the configuration and operation of media synchronization control section 230 is as follows.

Media synchronization control section 230 is a structural element newly added to the related art and manages the amount of data stored in media buffer 250 and the data number of stored data, carries out control according to the storage amount of media buffer 250 in reception of data from CN 400, and transmits data to switching source terminal 100 in the event that there is no space in media buffer 250. Further, in the event that data of the newest data number to be outputted to decoder 260 is not stored in media buffer 250, it is possible to maintain data number continuity by acquiring data of the newest data number from switching source terminal 100.

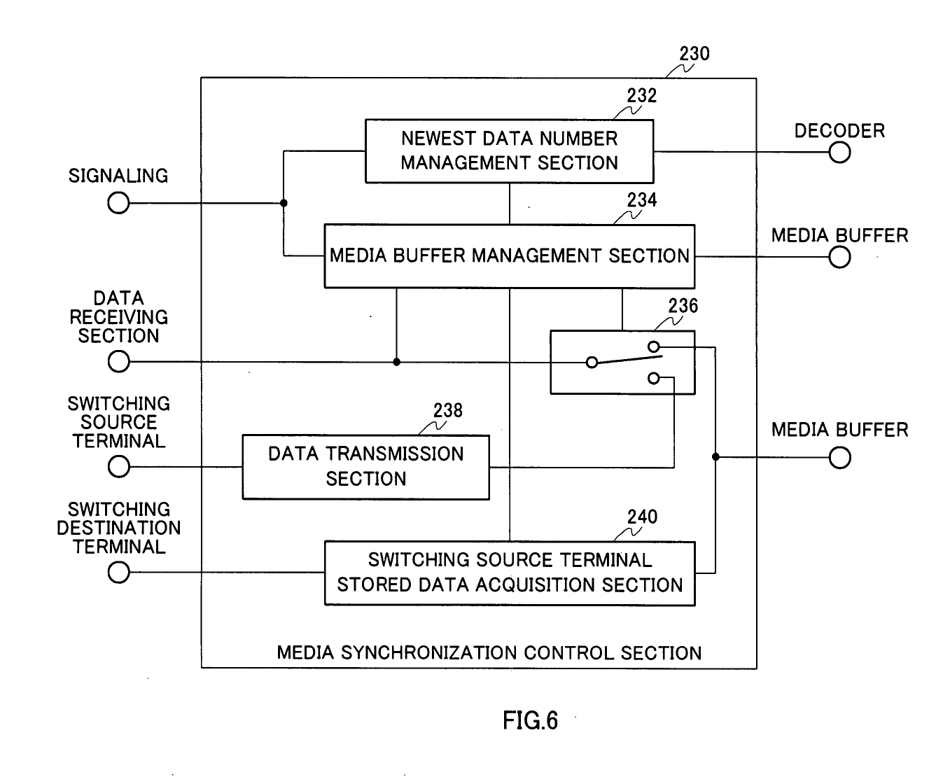

FIG. 6 is a block diagram showing an internal configuration of media synchronization control section 230.

Media synchronization control section 230 is configured with newest data number management section 232, media buffer management section 234, switch 236, data transmission section 238, and switching source terminal stored data acquisition section 240.

Newest data number management section 232 holds newest data number received from signaling section 210, increments the newest data number when decoder 260 acquires data from media buffer 250, and reports the updating to media buffer management section 234.

Media buffer management section 234 manages the amount of data stored in media buffer 250 and the data numbers of stored data. In the event that there is no space in media buffer 250 when data receiving section 220 receives data from CN 400, the received data is transmitted to data transmission section 238, and in the event that there is space in media buffer 250, the received data is stored to media buffer 250. Further, in the event that data for the newest data number does not exist in media buffer 250 when updating of the newest data is reported from newest data number management section 232, switching source terminal stored data acquisition section 240 is instructed to acquire data for the newest data number from media buffer 160 of switching source terminal 100.

Switch 236 then switches output of data received by data receiving section 220 from CN 400 to media buffer 250 or data transmission section 238 according to determination of media buffer management section 234.

In the event that there is no space in media buffer 250, data transmission section 238 transmits data that is received by data receiving section 220 from CN 400 and transmitted from media buffer management section 234 to switching source terminal 100 for use as a virtual buffer.

Switching source terminal stored data acquisition section 240 acquires data for newest data numbers from switching source terminal 100 based on acquisition report of data for newest data numbers by media buffer management section 234 and writes this data to media buffer 250.

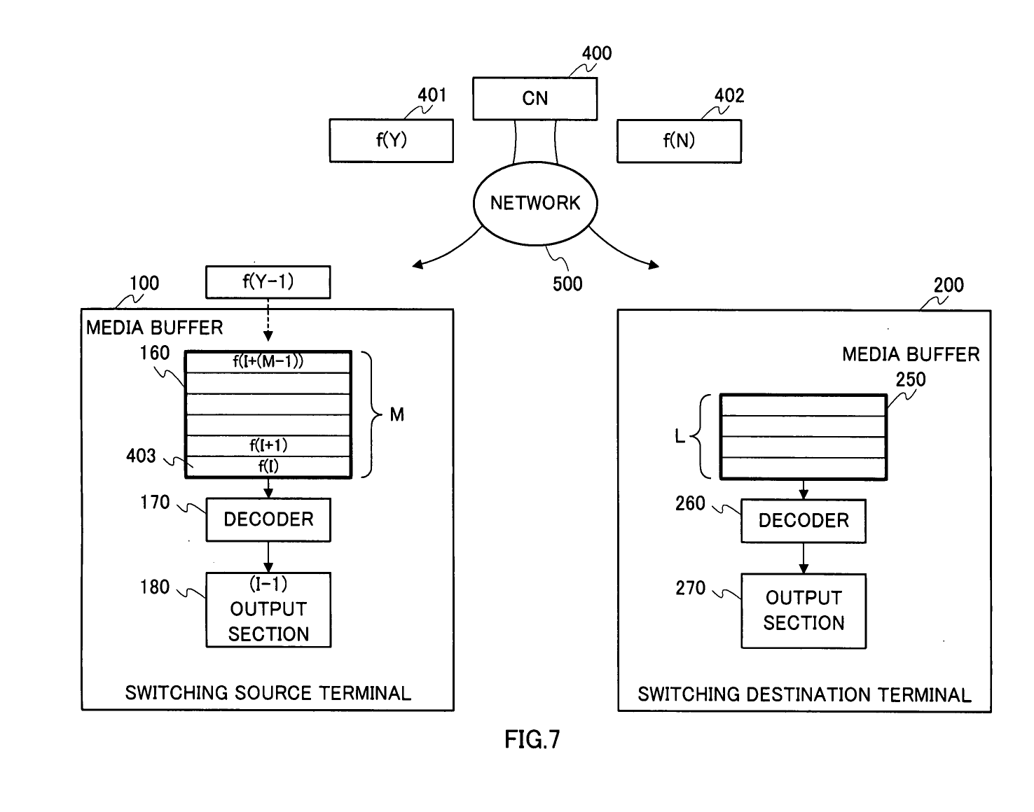

Before describing the details of the operation of switching destination terminal 200, assumptions common to terminal switching technology in general will be described using FIG. 7. FIG. 7 shows a terminal switching system having switching source terminal 100, switching destination terminal 200, CN 400 and network 500.

As shown in FIG. 7, the buffer size of media buffer 160 of switching source terminal 100 is M and is capable of holding a maximum of M items of data. On the other hand, buffer size of media buffer 250 of switching destination terminal 200 is L. Typically, the sizes of M and L are different. FIG. 7 shows a state during terminal switching processing. In FIG. 7, M items of data are held that are prebuffered in media buffer 160 of switching source terminal 100. On the other hand, media buffer 250 of switching destination terminal 200 is in an empty state.

Decoders 170, 260 of terminals 100, 200 read out data of media buffers 160, 250 at fixed intervals and carry out decode processing, and the results of the decode processing are transmitted to output sections 180, 270. When the data is 30 frames per second of image data, decoders 170, 260 acquire image data for one frame from media buffers 160, 250 every 1/30 seconds. In FIG. 7, I−1th data is outputted at output section 180 of switching source terminal 100. Data 403 is then stored in media buffer 160 as data to be acquired next from decoder 170. The data is referred to as “newest data”, and the data number of the newest data is referred to as “newest data number”. The symbol described in data 403 etc., for example, f (I) indicates Ith data, with “I” meaning the number of the data.

Data 401 and data 402 indicate data transmitted from CN 400 to switching source terminal 100 and switching destination terminal 200 respectively. CN 400 is capable of starting data transmission to switching destination terminal 200 by establishing a session between CN 400 and switching destination terminal 200. Data 402 is the earliest data to be transmitted, and is Nth data f (N). On the other hand, data 401 transmitted to switching source terminal 100 at this time is Yth data f (Y). Typically, N and Y are different, and data 401 and data 402 can not be synchronized.

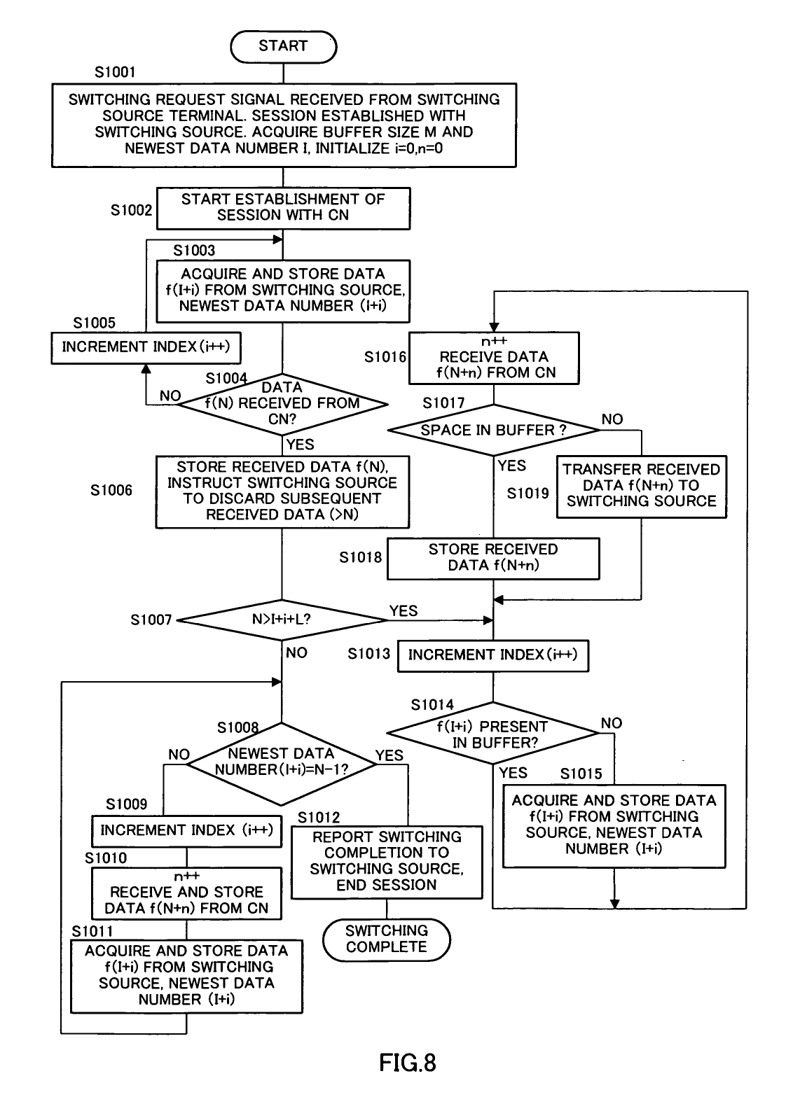

In view of the assumptions common to terminal switching technology in general described above, the operation of switching destination terminal 200 will be described using the flowchart of FIG. 8.

With this flowchart, by repeating step S1013 to step S1019, decoder 260 prevents media buffer 250 from overflowing, and is capable of acquiring data of consecutive data numbers continuously.

Before operation of switching destination terminal 200 starts, switching source terminal 100 receives a terminal switching request from a user and starts terminal switching operation. Specifically, a terminal switching request is reported by transmitting an SIP “REFER” message to switching destination terminal 200 as described above. Switching source terminal 100 describes the buffer size M of media buffer 160 of switching source terminal 100 and I that is the newest data number stored in media buffer 160 in the header or the payload of the message for each transmission of a message. Further, switching source terminal 100 establishes a session for transmitting and receiving data to and from switching destination terminal 200.

Upon receiving a session switching request from switching source terminal 100, switching destination terminal 200 acquires buffer size M and newest data number I and holds them in a register (not shown) of newest data number management section 232. Further, index i of the newest data number and index n of data received from CN 400 are initialized to 0.

Moreover, signaling section 210 establishes a session for transmitting and receiving data to and from switching source terminal 100 according to a session establishment request from switching source terminal 100 (S1001). Signaling section 210 transmits an SIP “INVITE” message to CN 400 in order to establish a session with CN 400 (S1002). Data is not transmitted from CN 400 until a session is established.

Data f (I+i) for the newest data number (I+i) does not exist in media buffer 250 so media buffer management section 234 instructs switching source terminal stored data acquisition section 240 to acquire f(I+i) from switching source terminal 100. Receiving this, switching source terminal stored data acquisition section 240 acquires f(I+i) from media buffer 160 of switching source terminal 100, and writes this to media buffer 250 (S1003).

Newest data number management section 232 monitors the timing of decoder 260 acquiring the newest data from media buffer 250 and reports this to media buffer management section 234 in the event of data acquisition. In the event that data receiving section 220 does not receive data f (N) from CN 400 during up to decoder 260 acquiring the newest data (S1004: NO), index i of the newest data number is incremented (i++) (S1005: (i++) means taking a current value for i with 1 added as i thereafter, with the same hereinafter), and step S1003 is proceeded to.

On the other hand, up to decoder 260 acquiring the newest data, in the event that data receiving section 220 receives data f (N) from CN 400 (S1004: YES), media buffer management section 234 connects the output of switch 236 to the media buffer side, and writes data f (N) to media buffer 250. Further, even if data after the Nth data is received at switching source terminal 100 from CN 400 via signaling section 210, instruction is given for this data to be discarded without being written to media buffer 160 (S1006).

In the event that N>(I+i)+L does not hold true from the relationship of the newest data number (I+i), the buffer size L of media buffer 250, and the earliest data number N to arrive from CN 400 (S1007: NO), media buffer management section 234 examines the relationship between the newest data number (I+i) and N inthe following manner (S1008).

In the event that N−1=I+i does not hold true (S1008: NO), media buffer management section 234 increments index i of the newest data number at the timing of decoder 260 acquiring the newest data from media buffer 250 (S1009). While data receiving section 220 receives the next data from CN 400, index N of data received from CN 400 is incrementd (n++), and data f (N+n) is written to media buffer 250 (S1010). Data f (I+i) for the newest data number (I+i) does not exist in media buffer 250 so media buffer management section 234 instructs switching source terminal stored data acquisition section 240 to acquire this from switching source terminal 100. Receiving this, switching source terminal stored data acquisition section 240 acquires f (I+i) from media buffer 160 of switching source terminal 100, and writes this to media buffer 250 (S1011).

By repeating the above operation (S1009 to S1011), in the event that N−1 =I+i holds true (S1008: YES), the prebuffer state within media buffer 250 of switching destination terminal 200 is complete. Media buffer management section 234 then ends the session with switching source terminal 100 at the same time as transmitting terminal switching completion report to switching source terminal 100 (S1012), and concludes processing relating to terminal switching.

On the other hand, in the event that N>(I+i)+L holds true (S1007: YES), media buffer management section 234 increments index i of the newest data number to (i++) at the timing of decoder 260 acquiring the newest data from media buffer 250 (S1013), and confirms whether or not data f (I+i) of the newest data number (I+i) exists in media buffer 250 (S1014). In the event that data f (I+i) does not exist (S1014: NO), media buffer management section 234 instructs acquisition of f(I+i) from switching source terminal 100 to switching source terminal stored data acquisition section 240. Receiving this, switching source terminal stored data acquisition section 240 acquires f(I+i) from media buffer 160 of switching source terminal 100, writes this to media buffer 250 (S1015), and proceeds to step S1016.

In the event that data f (I+i) exists (S1014: YES), media buffer management section 234 increments index N of data received from CN 400 to (N++) when data receiving section 220 receives the next data from CN 400 (S1016), and checks the space inmedia buffer 250 (S1017). At this time, in the event that space for storing data exists in media buffer 250 (S1017: YES), data f (N+n) is written to data buffer 250 (S1018). On the other hand, in the event that space for storing data does not exist in media buffer 250 (S1017: NO), media buffer management section 234 connects the output of switch 236 to the side of the data transmission section and transmits data f (N+n) to data transmission section 238. Data transmission section 238 then transfers the data to switching source terminal 100 (S1019).

Decoder 260 is then capable of acquiring data of consecutive data numbers continuously while preventing media buffer 250 from overflowing by repeating the above operation (S1013 to S1019).

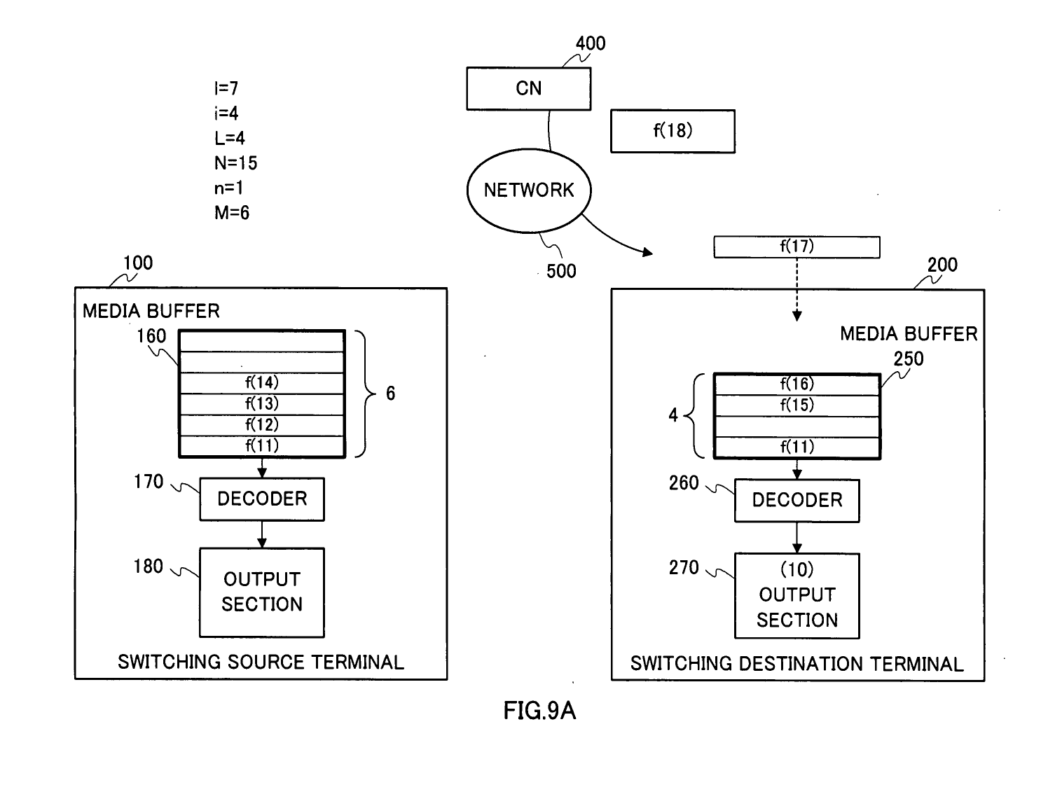

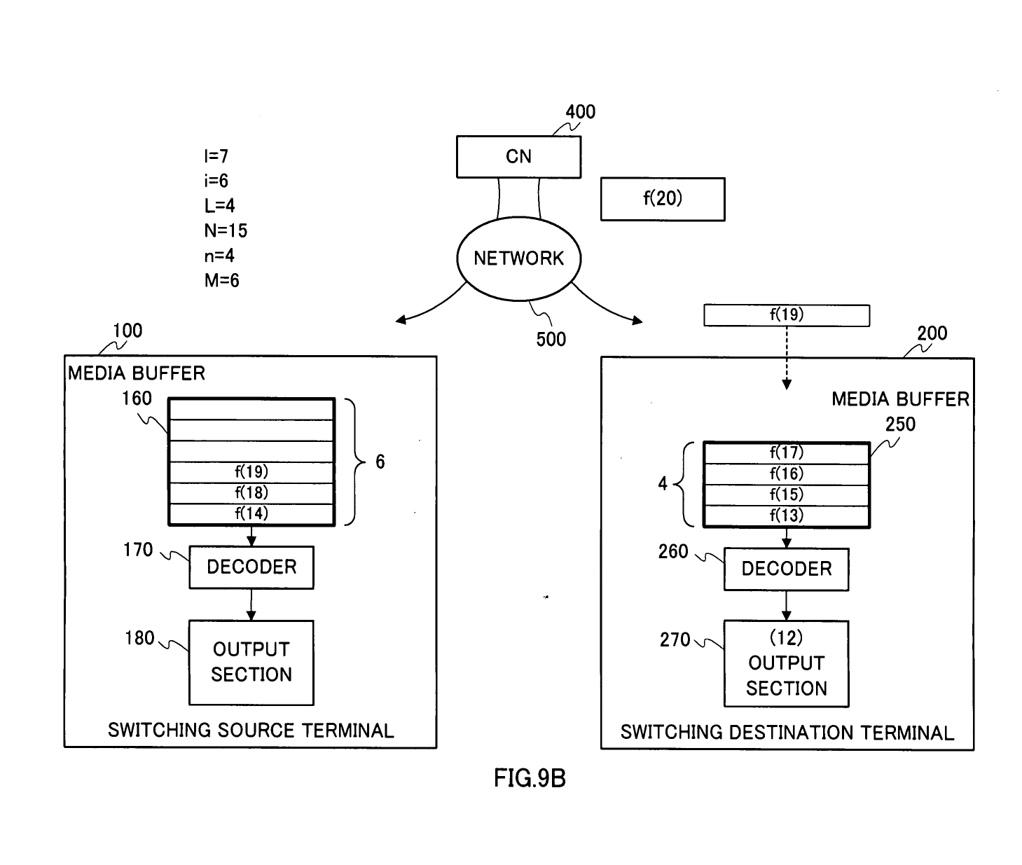

FIG. 9A and FIG. 9B are cut-away views for a certain instant in the operation of a seamless terminal switching system containing switching destination terminal 200 described above. The content of the drawings is the same as used in FIG. 7 but the following specific numerical values are given to aid understanding. Assume that buffer size M of media buffer 160 is 6, and buffer size L of media buffer 250 is 4. The newest data number at the time of switching is 7, and the earliest data number N arriving from CN 400 is 15, and i arrives at switching destination terminal 200 at the timing 2. With these settings, N>(I+i)+L holds true (S1007: YES).

FIG. 9A is a cut-away of the state at the instant that index i is 4 and index n is 1. Data of data number 10 is already outputted at output section 270, and the newest data number is 11. FIG. 9A is a state where, since f (11) does not exist within media buffer 250 (S1014: NO), f (11) is acquired from media buffer 160 of switching source terminal 100, and is the state immediately after writing to media buffer 250 (S1015). Here, since N is 15, data of data numbers after 15 are discarded (S1006), and discarded data of data numbers after 15 are not stored in media buffer 160 of switching source terminal 100. Further, switching source terminal 100 deletes data acquired by switching source terminal stored data acquisition section 240 from media buffer 160.

FIG. 9B is a cut-away of the state at the instant that index i is 6 and index n is 4. Data of data number 12 is already outputted at output section 270, and the newest data number is 13. The state of FIG. 9B is a state where, when data receiving section 220 receives f (19) (S1016), there is no space in media buffer 250, and f (19) is transferred to switching source terminal 100 by data transmission section 238 (S1019), and is the state immediately after writing to media buffer 160. f (18) already stored in media buffer 160 is similarly transferred from switching destination terminal 200.

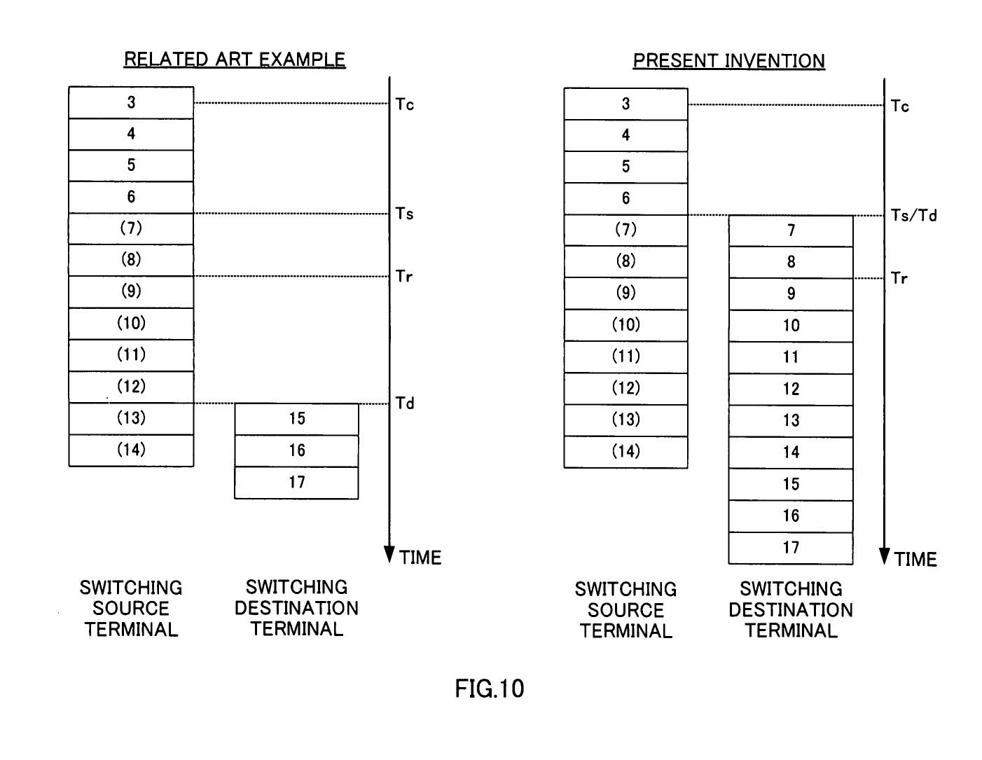

FIG. 10 is a comparison of results for terminal switching apparatus of the related art and terminal switching apparatus of the present invention under the same settings as the example shown in FIG. 9A and FIG. 9B. The left half of FIG. 10 shows the output (switching source output) of switching source terminal 10 in the terminal switching system of the related art and the output (switching destination output) of switching destination terminal 40, and the right half of FIG. 10 shows the output (switching source output) of switching source terminal 100 of the terminal switching system of the present invention and the output (switching destination output) of switching destination terminal 200.

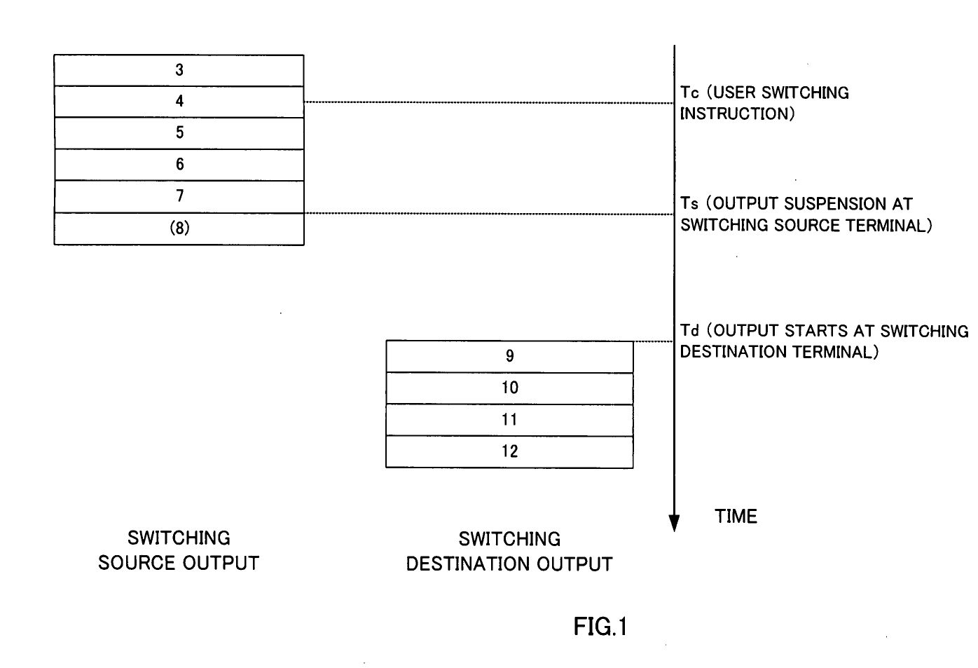

Here, as described for the seamless terminal switching shown in FIG. 1, it is assumed that the user outputs a switching instruction to switching source terminals 10, 100 at time Tc, switching source terminals 10, 100 stop output of data at time Ts, and switching destination terminals 40, 200 start output of data at time Td. Regarding stopping output of data at switching source terminals 10, 100, special processing such as intentionally delaying the output stop time is not carried out. The time Ts is therefore assumed to be the same time for both the terminal switching system of the related art and the terminal switching system of the present invention. Further, time Ts is the time of switching destination terminals 40, 200 receiving session switching requests from switching source terminals 10, 100 and index i is initialized to 0.

Tr is the time of arrival of final data f (15) from CN 20, 400. Given the setting of this example, data f (15) arrives at switching destination terminals 40, 200 at the time the index i is 2.

In FIG. 10, at the switching destination terminal 40 of the related art, after time Tr, data f (15) cannot be outputted until data is prebuffered in media buffer 46. As buffer size L of media buffer 46 is 4, f (15) is outputted for the first time at time Td. As a result, output of data at switching source terminal 10 is stopped, and time gap Td-Ts that is the time up to the start of data output at switching destination terminal 40 is 6.

Further, the media gap that is the difference between the number of data outputted at switching destination terminal 40 at time Td and the number of data outputted at switching source terminal 10 at time Ts is 15−6−1=8.

On the other hand, in FIG. 10, at switching destination terminal 200 of the present invention, switching destination terminal 200 is capable of outputting f (7) at time Ts by acquiring data f (7) from media buffer 160 of switching source terminal 100 at time Ts. Namely, Ts and Td are the same time, and time gap Td-Ts is 0. Further, the media gap is 7−6−1=0. As a result, it can be understood that the time gap and media gap can be made 0 without increasing response delay Td-Tc, and compared to the terminal switching system of the related art, it is possible to implement seamless terminal switching.

Further, data received from CN 400 after time Tr is held in media buffers 250, 160 of switching destination terminal 200 or switching source terminal 100, and outputted at a time so that data output at switching destination terminal 200 can be continuous, and therefore data output after switching cannot be discontinuous.

As is clear from the above description, by supplying data of media buffer 160 of switching source terminal 100 to media buffer 250 using switching source terminal stored data acquisition section 240 from immediately after receiving a switching request from switching source terminal 100, it is possible to use media buffer 160 as a logical media buffer for switching destination terminal 200.

By this means, a prebuffer state of switching destination terminal 200 can be ensured, and decoder 260 is capable of starting decode processing immediately without waiting for data being physically prebuffered in media buffer 250. As a result, it is possible to make the time gap close to almost zero. Further, a session is established with CN 400, and after data arrives from CN 400, media buffer management section 234 confirms the data storage state of media buffer 250. In the event that there is no space in media buffer 250, it is possible to prevent data loss due to overflow of media buffer 250 by writing to media buffer 160 of switching source terminal 100.

On the other hand, when data of the newest data number does not exist in media buffer 250, media buffer management section 234 is capable of ensuring data number continuity by acquiring this data from media buffer 160 of switching source terminal 100.

With the above, it is possible to implement seamless terminal switching.

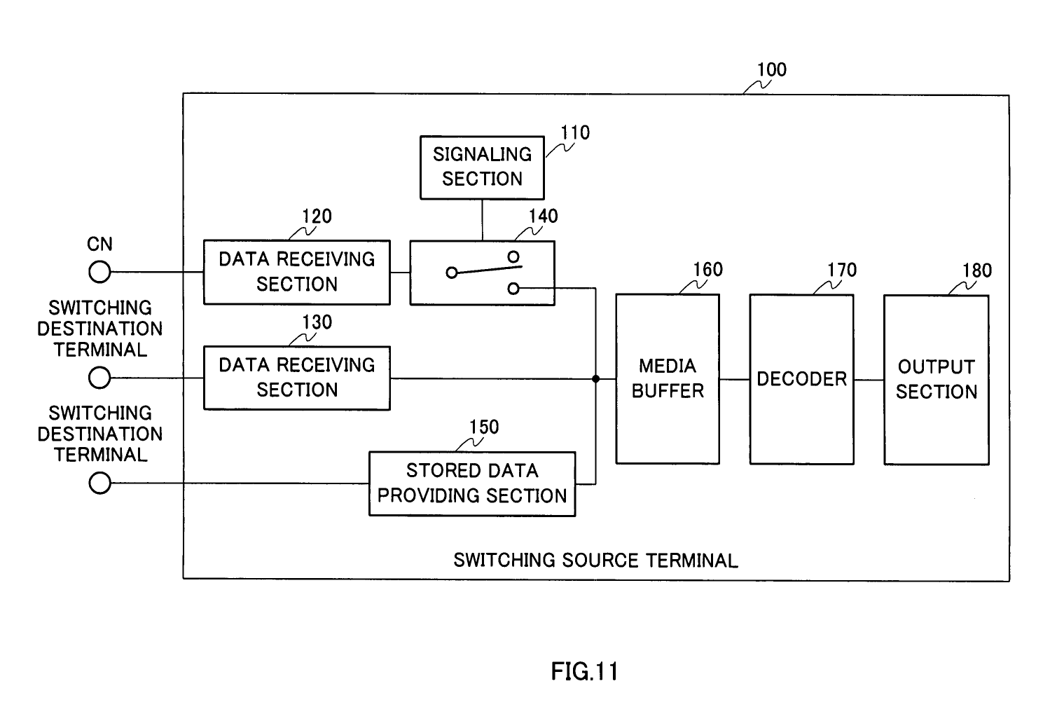

Next, the configuration and operation of switching source terminal 100 will be described using FIG. 11. Structural elements that are the same as structural elements shown in FIG. 7 are given the same numerals.

Switching source terminal 100 has signaling section 110 controlling sessions between switching destination terminal 200 and CN 400, data receiving section 120 receiving data transmitted by CN 400, data receiving section 130 receiving data transmitted by switching destination terminal 200, switch 140 switching between media buffer 160 and discarding for output of data received from CN 400, stored data providing section 150 transmitting desired data from media buffer 160 when there is a data acquisition request from switching destination terminal 200, media buffer 160 storing received data, decoder 170 decoding received data, and output section 180 outputting data decoded by decoder 170.

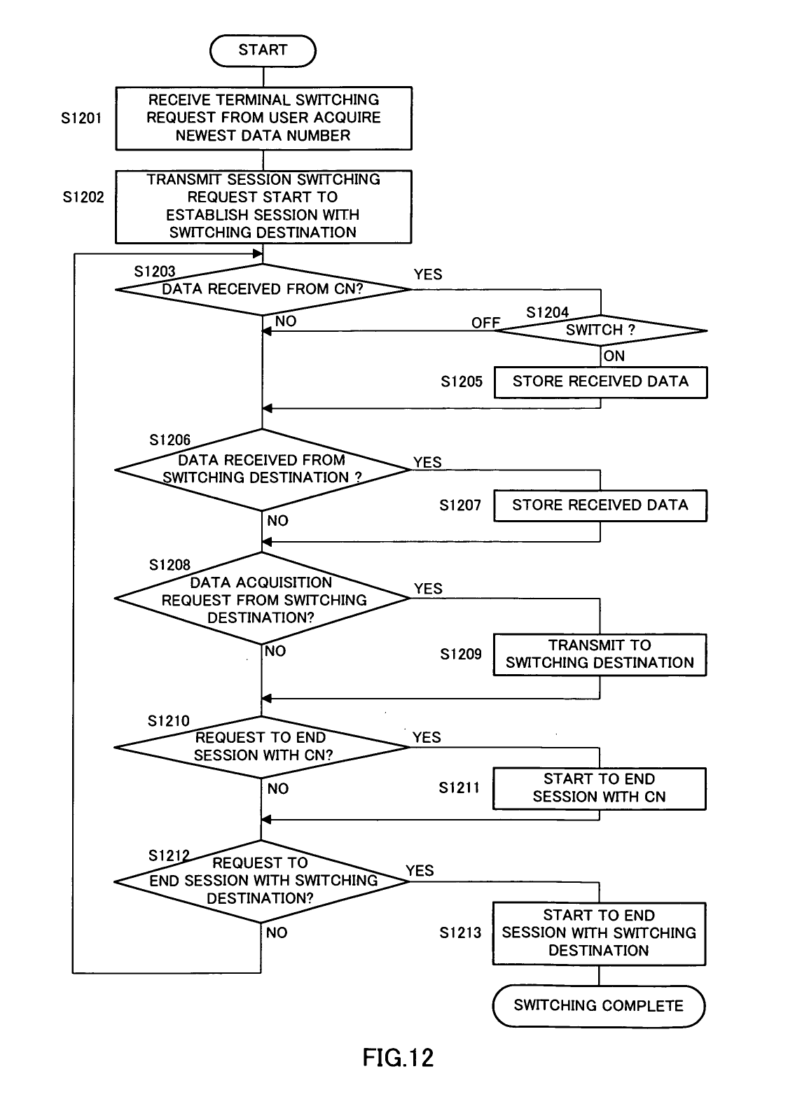

Next, the operation of switching source terminal 100 will be described in detail using FIG. 12.

Before receiving a terminal switching request from a user, switching source terminal 100 is in a state of establishing a session with CN 400. At this time, switch 140 is on, and data receiving section 120 receives data from CN 400 and writes the received data to media buffer 160.

When a terminal switching request is received from a user, switching source terminal 100 accesses media buffer 160 and acquires newest data number I (S1201). Signaling section 110 describes buffer size M of media buffer 160 and newest data number I in the header or the payload of the terminal switching request message and transmits this to switching destination terminal 200. Further, establishment of a session for transmitting and receiving data to and from switching destination terminal 200 is started (S1202).

In the event that data receiving section 120 receives data from CN 400 (S1203: YES), if switch 140 is on (S1204: YES), the received data is stored in media buffer 160 (S1240). Even if signaling section 110 receives data for after the Nth data from CN 400, when an instruction is received from switching destination terminal 200 to discard without writing to media buffer 160, switch 140 is switched to off after data receiving section 120 receives f (N). As a result, data received from CN 400 thereafter is discarded without being stored in media buffer 160.

In the event that data receiving section 130 receives data from switching destination terminal 200 (S1206: YES), the received data is stored in media buffer 160 (S1207).

In the event that stored data providing section 150 receives a data acquisition request from switching destination terminal 200 (S1208: YES), the data is acquired from media buffer 160 and transmitted to switching destination terminal 200 (S1209). When the corresponding data is acquired from media buffer 160, the data is deleted from media buffer 160.

When a session is established between CN 400 and switching destination terminal 200, session mobility is achieved, and a session between CN 400 and switching source terminal 100 is no longer necessary. In the event that signaling section 110 receives a request to end the session between CN 400 and switching source terminal 100 from CN 400 (S1210: YES), processing to end the session with CN 400 is started (S1211).

This ending processing may be carried out from switching source terminal 100 by a completion report of establishment of a session with CN 400 (session switching request response, for example, response to “REFER” message) being received from switching destination terminal 200.

In the event that a prebuffer state is complete within media buffer 250 of switching destination terminal 200 and a request to end a session between switching destination terminal 200 and switching source terminal 100 in order to end processing relating to terminal switching is received by signaling section 110 (S1212: YES), processing is started to end the session with switching destination terminal 200 (S1213).

In the event that signaling section 110 does not receive a request to end a session between switching destination terminal 200 and switching source terminal 100 (S1212: NO), switching source terminal 100 repeats the above operation of (S1203 to S1212).

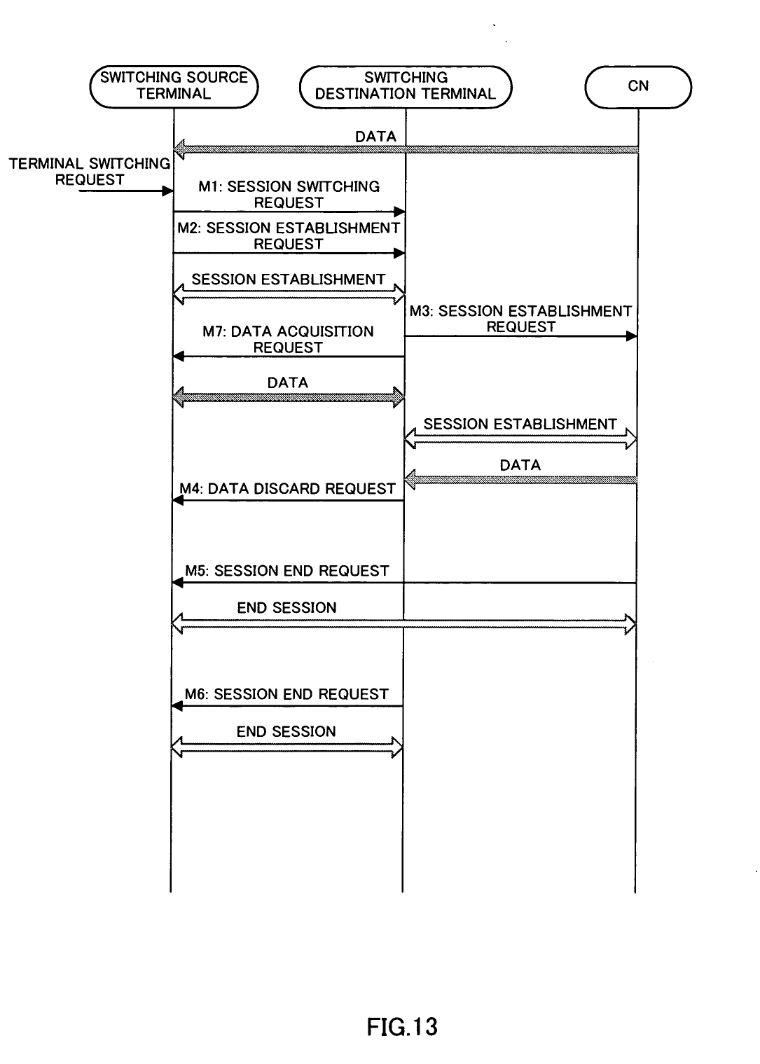

Next, a message sequence exchanged among switching source terminal 100, switching destination terminal 200, and a third party of CN 400 will be described using FIG. 13.

Switching source terminal 100 receives a terminal switching request from a user (S1201) and starts terminal switching processing. Switching source terminal 100 then transmits session switching request M1 to switching destination terminal 200 (S1202, S1001). Terminal switching request M1 transmitted by signaling section 110 to switching destination terminal 200 can use an SIP “REFER” message.

Further, at the same time, switching source terminal 100 transmits session establishment request M2 to switching destination terminal 200 in order to establish a session with switching destination terminal 200 (S1202, S1001). Session establishment request M2 can use an SIP “INVITE” message.

Switching destination terminal 200 receives session switching request M1 and transmits session establishment request M3 to CN 400 in order to establish a session with CN 400 (S1002). Session establishment request M3 can use an SIP “INVITE” message.

After a session is established with CN 400 and switching destination terminal 200 starts to receive data from CN 400 (S1004: YES), switching destination terminal 200 transmits data discard request M4 instructing to discard data without writing the data to media buffer 160 even if data for after the Nth data is received from CN 400, to switching source terminal 100 (S1006). A message other than SIP may be used as data discard request M4 providing that data number N is described.

After establishing a session between CN 400 and switching destination terminal 200, CN 400 transmits session end request M5 for ending a session with switching source terminal 100 to switching source terminal 100 (S1210: YES). Session end request M5 can use an SIP “BYE” message.

When terminal switching is complete (S1008: YES), switching destination terminal 200 transmits session end request M6 to switching source terminal 100 and ends a session with switching source terminal 100 (S1012, S1213) An SIP “BYE” message can be used as session end request M6 transmitted to switching source terminal 100.

In order for switching destination terminal 200 to acquire data that does not exist in media buffer 250, a message other than SIP can be used as data acquisition request M7 transmitted from switching source terminal stored data acquisition section 240 to stored data providing section 150 of switching source terminal 100 (S1003, S1O11, S1015, S1208) provided that the data number of data which switching destination terminal 200 is wished to acquire is described.

As described above, according to this embodiment, by using media buffer 160 of switching source terminal 100 as a logical (or virtual) media buffer for switching destination terminal 200, it is possible to generate a prebuffer state from immediately after the terminal switching request. Further, the data storage state of media buffer 250 of switching destination terminal 200 is confirmed, and in the event that there is no space in media buffer 250, data is written to media buffer 160 of switching source terminal 100, it is therefore possible to prevent data loss due to overflow of media buffer 250. Further, when data of the newest data number does not exist in media buffer 250 of switching destination terminal 200, as this data is acquired from media buffer 160 of switching source terminal 100, it is possible to ensure data number continuity and implement seamless terminal switching.

The functions and operations implemented in this embodiment may be carried out by a program of a computer. In this case, memory (not shown) storing this program and a CPU etc. carrying out control are provided with switching source terminal 100, switching destination terminal 200, or CN 400. Further, the media for storing the program may be an external storage media such as, for example, an EPROM, flash EEPROM, or CD-ROM etc. These points, although not described, are also the same for other embodiments.

### Embodiment 2

Next, a terminal switching system of embodiment 2 of the present invention will be described.

The terminal switching system of this embodiment, with regards to the seamless terminal switching performance, is the same as the terminal switching system of embodiment 1, but intended to substantially improve convenience for the user after terminal switching.

The terminal switching system of this embodiment is provided with a delay control section for delaying the arrival of data from a communicating party with respect to a communicating party in the event that there is no space for storing data received from a communicating party at a storing section after a streaming session is established between terminal apparatus and communicating party and the data receiving section starts to receive data from the communicating party.

Here, two aspects will be described.

First, a first aspect of this embodiment will be described.

The first aspect is the case of delaying the arrival of data from a communicating party by stopping transmission of data for just a predetermined time.

In embodiment 1, in the event that N>(I+i)+L holds true (S1007: YES), in order to prevent media buffer 250 from overflowing, switching destination terminal 200 uses media buffer 160 of switching source terminal 100 in order to hold data transmitted from CN 400.

As a result, the exchange of data between switching source terminal 100 and switching destination terminal 200 continues permanently (S1013 to S1019), and it is not possible to end the session between switching source terminal 100 and switching destination terminal 200.

As far as the user is concerned, after terminal switching, it is preferable for the user simply to be able to carry switching destination terminal 200 around without being aware of the communication conditions between switching source terminal 100 and switching destination terminal 200. For example, in the event that switching source terminal 100 is a fixed television and switching destination terminal 200 is a mobile terminal, it is possible to switch the streaming session received by the fixed television to a mobile terminal, and take the mobile terminal outside a room etc. while continuing the session.

The seamless terminal switching system of this embodiment provides improvement with regards to this point so that, after a fixed time passes, it becomes unnecessary to use media buffer 160 of switching source terminal 100 in order to hold data transmitted from CN 400.

The basic configuration of the switching destination terminal of this embodiment is identical to the configuration of the switching destination terminal 200 of embodiment 1, with only the operation of the media synchronization control section and the signaling section being different. As a result, in this embodiment, the same numerals as for embodiment 1 are given to each of the structural elements and description of the configuration thereof is omitted. However, in order to provide distinction with embodiment 1, the switching destination terminal of this embodiment is shown by 200a (not shown). In the following, the operation of switching destination terminal 200a of this embodiment will be described taking note of the operation of media synchronization control section 230 and signaling section 210.

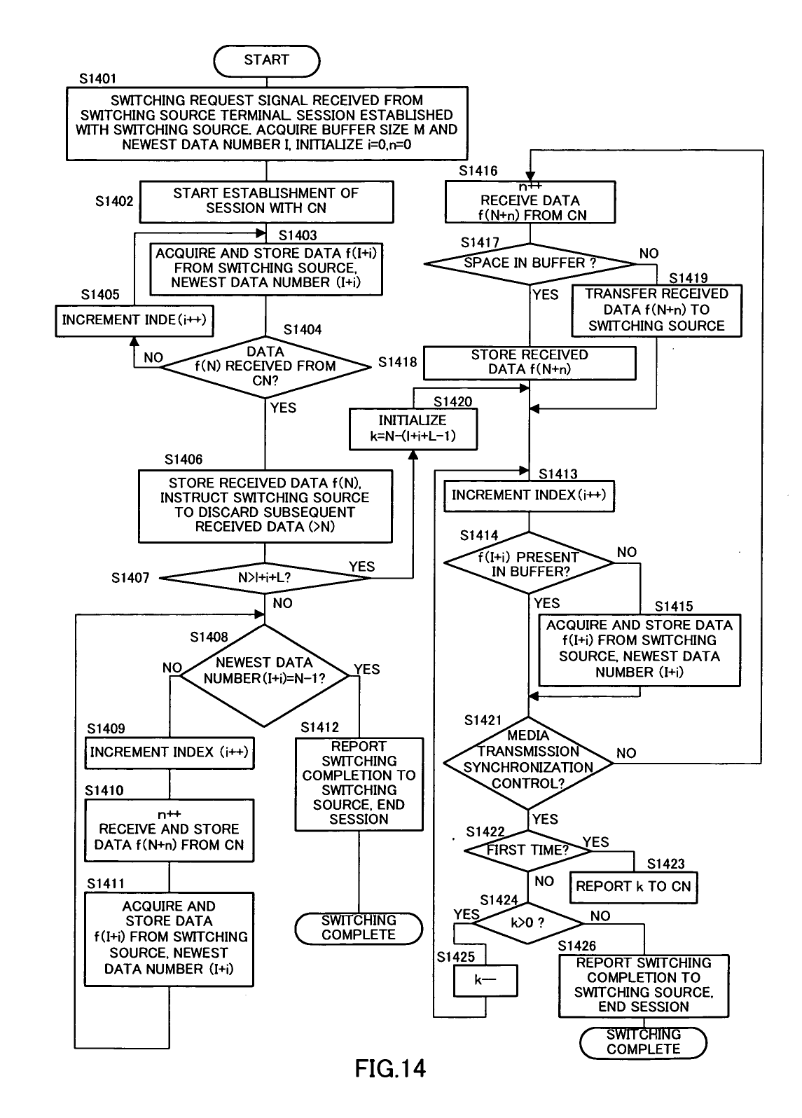

FIG. 14 is a flowchart illustrating the operation of a switching destination terminal of a terminal switching system of embodiment 2 of the present invention. In FIG. 14, a large number of processes (S1401 to S1419) are identical to the case of embodiment 1 shown in FIG. 8 and description of duplicated portions is therefore omitted except when necessary.

When switching destination terminal 200a receives data f (N) from CN 400, in the event that N>(I+i)+L holds true (S1407: YES) from the relationship among newest data number (I+i), buffer size L of media buffer 250, and earliest data number N arrived from CN 400, media buffer management section 234 initializes index k for media transmission synchronization control to N−(I+i+L−1) (S1420).

The value of k is decided by newest data number (I+i), earliest arriving data number N from CN 400, and size L of media buffer 250. This means that the size of media buffer 250 of switching destination terminal 200a is insufficient by only a value of k to implement seamless terminal switching with just switching destination terminal 200a.

In this embodiment, in the event that media transmission synchronization control is not carried out on CN 400 (S1421: NO), media buffer management section 234 repeats the stationary state (S1413 to S1419) of embodiment 1. On the other hand, in the event of carrying out media transmission synchronization control on CN 400 (S1421: YES), only for the first time (S1422: YES), CN 400 is instructed via signaling section 210 to pause transmission of data to switching destination terminal 200a just k times (S1423).

In the event that k is a positive value (S1424: YES), index k for media transmission synchronization control is decremented (S1425). On the other hand, in the event that k is not a positive value (S1424: NO), a prebuffer state is complete within media buffer 250 of switching destination terminal 200a. Media buffer management section 234 then ends the session with switching source terminal 100 at the same time as transmitting terminal switching completion report to switching source terminal 100 via signaling section 210 (S1426), and processing relating to terminal switching is complete.

In this way, media buffer management section 234 instructs CN 400 to pause transmission of data to switching destination terminal 200a via signaling section 210 (S1423), and data receiving section 220 does not receive data from CN 400 for just a fixed period where k is a positive value. On the other hand, decoder 260 acquires the newest data from media buffer 250 at fixed intervals regardless of whether or not data is received from CN 400. Media buffer management section 234 then increments index i of the newest data number at the timing of decoder 260 acquiring the newest data from media buffer 250 to (i++) (S1413), and confirms whether or not data f (I+i) for the newest data number (I+i) exists in media buffer 250 (S1414).

As a result, in the event that data f (I+i) does not exist (S1414: NO), media buffer management section 234 instructs acquisition of f (I+i) from switching source terminal 100 to switching source terminal stored data acquisition section 240. Switching source terminal stored data acquisition section 240 receives this instruction, acquires f(I+i) from media buffer 160 of switching source terminal 100, and writes this to media buffer 250 (S1415).

In this way, by pausing data transmission for CN 400, the total amount of data prebuffered is reduced, and the buffer size deficit for media buffer 250 can be maked up for.

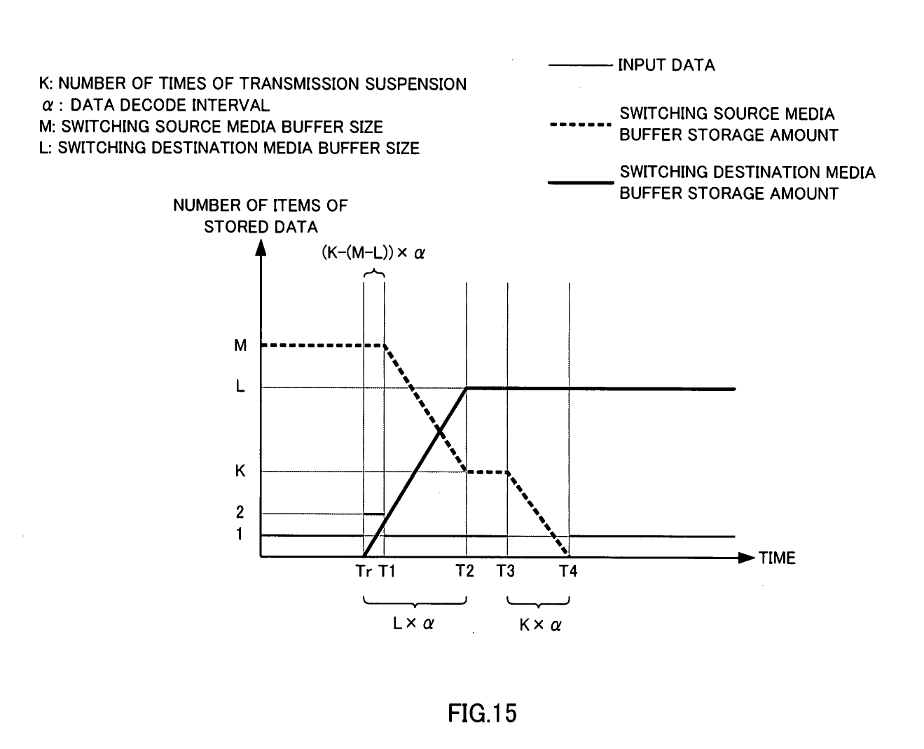

Next, the change with time in data stored in media buffer 160 of switching source terminal 100 and media buffer 250 of switching destination terminal 200a, respectively, in the first aspect of this embodiment will be described using the graph of FIG. 15.

In FIG. 15, the vertical axis of the graph is taken to be the storage data number, and the horizontal axis is taken to be time. The same numerals as used in the description of FIG. 7 are also used in the description of this graph. Namely, it is assumed that the media buffer size of switching source terminal 100 is M, the media buffer size of switching destination terminal 200a is L, and the newest data number is (I+i). Index k for media transmission synchronization control is N−(I+i+L−1). Here, the initial value of index k is assumed to be K (fixed value). Decoder 260 also carries out processing to read out and decode data at fixed intervals from media buffer 250 and the interval is assumed to be α. Further, an interval at which CN 400 transmits data is also α.

Next, the times in the graph will be described.

Tr is the same as used in FIG. 7, and is the time of switching destination terminal 200a receiving the most recently arrived data transmitted by CN 400. Further, the data number at this time is assumed to be N. Moreover, T1 is the time when switching source terminal 100 receives data of data number N from CN 400, and data received later than T1 is discarded (S1406). At time Tr, the newest data number is (I+i), and media buffer 160 of switching source terminal 100 stores data up to ((I+i)+(M−1)).

Time of (N−((I+i)+(M−1)))×α is required up to switching source terminal 100 receiving data of data number N. Here, K is N−(I+i+L−1), so that when K is used, the time from time Tr to Ti is (I−(M−L))×α.

T2 is a time of a state where media buffer 250 of switching destination terminal 200a is full, i.e. a time where, as a result of receiving data from CN 400, media buffer 250 of switching destination terminal 200a reaches a state where L items of data are stored. After time T2, switching destination terminal 200a starts transferring received data to switching source terminal 100 (S1419).

T3 is the time of starting media transmission synchronization control, and CN 400 stops transmission of data to switching destination terminal 200a for a fixed period. T4 is the time of ending media transmission synchronization control, and after time T4, CN 400 restarts transmission of data to switching destination terminal 200a.

In the graph of FIG. 15, the thick solid line indicates the amount of data stored in media buffer 250 of switching destination terminal 200a (switching destination media buffer storage amount), and the thick broken line indicates the amount of data stored in media buffer 160 of switching source terminal 100 (switching source media buffer stored amount). Further, the thin solid line indicates the amount of data transmitted from CN 400 inputted to a media buffer in the unit time α.

Next, the content of a graph will be described along a time axis from the left end of the graph.

Data is transmitted from CN 400 to switching source terminal 100 until time Tr. The amount of data inputted to media buffer 160 of switching source terminal 100 is one per unit time α. Switching destination terminal 200a acquires data from media buffer 160 of switching source terminal 100 and the amount of data stored in media buffer 160 of switching source terminal 100 is constant at M. On the other hand, media buffer 250 of switching destination terminal 200a promptly outputs data acquired from switching source terminal 100 to decoder 260 and therefore does not store data.

Upon time Tr, switching destination terminal 200a starts to receive data from CN 400 anew. The sum of the amount of data inputted to each media buffer 160, 250 of switching source terminal 100 and switching destination terminal 200a becomes 2 per unit time α. At this time, switching destination terminal 200a stores data received from CN 400, and the storage amount of media buffer 250 increases by 1/α. On the other hand, the storage amount is constant at M regardless of the conditions for switching source terminal 100.

Upon time T1, switching source terminal 100 discards data received from CN 400, and this data is not stored in media buffer 160. The sum of the amount of data inputted to each media buffer 160, 250 of switching source terminal 100 and switching destination terminal 200a then becomes 1 per unit time α. At this time, on the one hand, data is not inputted to media buffer 160 of switching source terminal 100, while on the other hand switching destination terminal 200a acquires data from media buffer 160 of switching source terminal 100. The storage amount of media buffer 160 of switching source terminal 100 is then reduced by 1/α. On the other hand, the storage amount increases by 1/α regardless of the state of switching destination terminal 200a.

Upon time T2, media buffer 250 of switching destination terminal 200a becomes full. Data is then still inputted only to switching destination terminal 200a and the amount of inputted data is 1 per unit time α. At this time, switching destination terminal 200a transfers data received from CN 400 to switching source terminal 100 and the storage amount of media buffer 250 is constant at L. Switching source terminal 100 receives data from switching destination terminal 200a and transmits data to switching destination terminal 200a at the same time as storing this data in media buffer 160. The storage amount of media buffer 160 is therefore constant at K. Here, media buffer 250 of switching destination terminal 200a increases from time Tr at speed 1/α, and reaches L at time T. The time from time Tr to T2 is L×α.

Upon time T3, CN 400 starts media transmission synchronization control, and CN 400 stops transmission of data to switching destination terminal 200a during the period of K×α. The amount of data inputted to media buffer 250 is 0 per unit time α. As a result, the storage amount of media buffer 250 of switching destination terminal 200a is constant at L. On the other hand, switching source terminal 100 transmits data to switching destination terminal 200a. The storage amount of media buffer 160 is therefore reduced by 1/α, and becomes 0 at time t4.

Upon time T4, CN 400 ends media transmission synchronization control, and data transmission is restarted at data interval α to switching destination terminal 200a. The amount of data inputted to media buffer 250 of switching destination terminal 200a is 1 per unit time α. At media buffer 250 of switching destination terminal 200a, data from CN 400 is inputted and outputted to decoder 260. The amount of data stored in media buffer 160 of switching source terminal 100 is then constant at L.

From the above, it is possible to reduce the total amount of prebuffered data to L, and it is not necessary to use media buffer 160 of switching source terminal 100.

Next, messages exchanged between switching destination terminal 200a and CN 400 will be described.

A message other than SIP can be used as a message instructed by switching destination terminal 200a to CN 400 to pause transmission of data by K times (S1423) providing that the value of K is described in the header or payload of the message.

CN 400 receiving the message pauses the transmission of data transmitted at a fixed interval α for the period of K×α. However, the number of transmitted data is not influenced in any way by this, and the initially predicted transmission time becomes just a time K×α ahead.

As described above, according to the first aspect of this embodiment, periodic data transmission by CN 400 is paused for just a predetermined time, while on the other hand, during this period, decoder 260 acquires data from media buffer 160 of switching source terminal 100. As a result, it is possible to make up for buffer size deficit of media buffer 250 of switching destination terminal 200a. As a result, switching destination terminal 200 ends a session with switching source terminal 100 after a fixed time without using media buffer 160 of switching source terminal 100, and seamless terminal switching can be implemented. This means that the convenience for the user after terminal switching is substantially improved.

Next, a second aspect of this embodiment will be described.

The second aspect is the case of delaying the arrival of data from a communicating party by making a data transmission interval from a communicating party large by a predetermined time. More specifically, arrival of data from a communicating party is delayed by, for example, setting a data transmission interval from a communicating party a predetermined time larger than a transmission interval (source session transmission interval) at which data is transmitted from the communicating party to a switching source terminal or larger than a transmission interval at which data is transmitted from the communicating party to a switching destination terminal immediately after terminal switching.

In the first aspect, it is possible to start media transmission synchronization control after time T2 (S1421: YES), and the total amount of data prebuffered in switching destination terminal 200a can be reduced to L by pausing transmission of data transmitted by CN 400 to switching destination terminal 200a during the period K×α from time T3 to time T4.

With regards to this, in this aspect, in place of pausing transmission of data from CN 400, by changing the data transmission interval of CN 400 from α to β, it is possible to reduce the total amount of data prebuffered in switching destination terminal 200a to L. According to this method, and it is possible to start media transmission synchronization control at an arbitrary time (S1421: YES) without waiting for time T2.

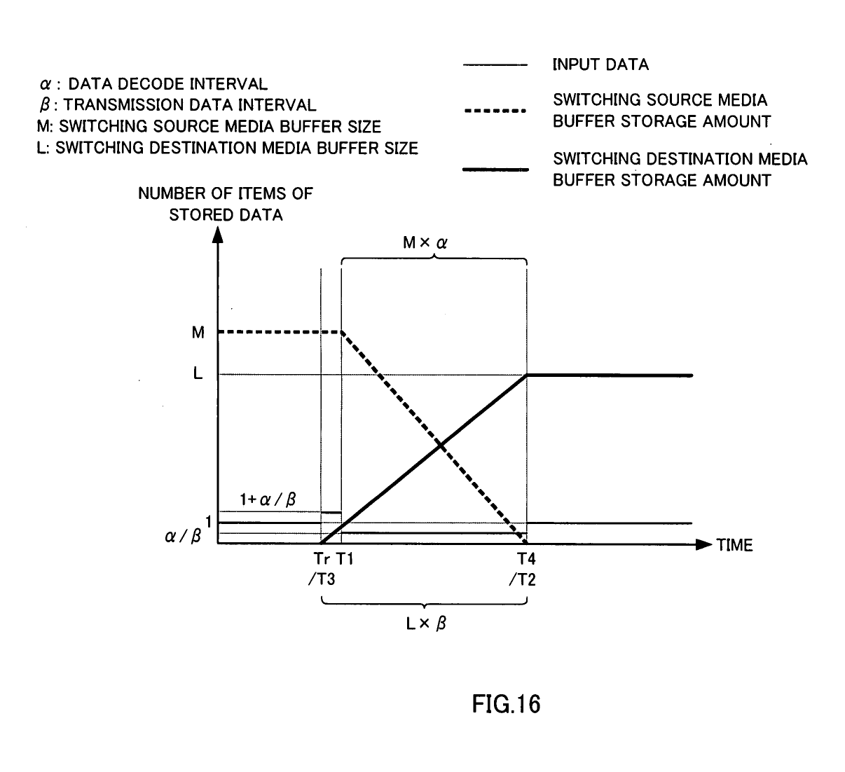

FIG. 16 is a graph showing the change in data stored in media buffer 160 of switching source terminal 100 and media buffer 250 of switching destination terminal 200a with time for a second aspect of the embodiment. With the exception of β, the numerals used in FIG. 16 are exactly the same as those used in FIG. 15. Here, β is the data transmission interval of CN 400 for after changing by the media transmission synchronization control, and is a value larger than α(β>α). Further, in FIG. 16, time T3 for starting media transmission synchronization control is the same time as Tr, and T3 and Tr therefore coincide.

Next, the content of a graph will be described along a time axis from the left end of the graph.

Data is transmitted from CN 400 to switching source terminal 100 until time Tr. The amount of data inputted to media buffer 160 of switching source terminal 100 is one per unit time α. Switching destination terminal 200a acquires data from media buffer 160 of switching source terminal 100 and the amount of data stored in media buffer 160 of switching source terminal 100 is constant at M. On the other hand, media buffer 250 of switching destination terminal 200a rapidly outputs data acquired from switching source terminal 100 to decoder 260 and therefore does not store data.

Upon time Tr, although switching destination terminal 200a starts to receive data anew from CN 400, CN 400 starts media transmission synchronization control, and the data transmission interval from CN 400 is set to be β, the amount of data inputted to media buffer 250 of switching destination terminal 200a is therefore (α/βper unit time α. Further, this is one per unit time α regardless of the amount of data inputted from CN 400 to media buffer 160 of switching source terminal 100.

The sum of the amount of data inputted to each media buffer 160, 250 of switching source terminal 100 and switching destination terminal 200a therefore becomes 1+α/β. At this time, switching destination terminal 200a stores data received from CN 400, and therefore the storage amount of media buffer 250 of switching destination terminal 200a increases by 1/β. On the other hand, the storage amount of media buffer 160 is constant at M regardless of the conditions of switching source terminal 100.

Upon time T1, switching source terminal 100 discards data received from CN 400 and does not store this data inmedia buffer 160. The sum of the amount of data inputted to each media buffer 160, 250 of switching source terminal 100 and switching destination terminal 200a then becomes α/β per unit time. At this time, on the one hand, data is not inputted to media buffer 160 of switching source terminal 100, while on the other hand switching destination terminal 200a acquires data from media buffer 160 of switching source terminal 100. The storage amount of media buffer 160 of switching source terminal 100 is then reduced by a speed of 1/α. On the other hand, regardless of the conditions of switching destination terminal 200a, the storage amount of media buffer 250 of switching destination terminal 200a increases by 1/β.

Upon time T2, media buffer 250 of switching destination terminal 200a becomes full. Then, by setting appropriate β as described in the following, at T4 that is the same time as time T2, CN 400 completes media transmission synchronization control, and data transmission is restarted at a data interval of α with respect to switching destination terminal 200a. The amount of data inputted to switching destination terminal 200a is one per unit time α. At this time, at media buffer 250 of switching destination terminal 200a, data from CN 400 is inputted and outputted to decoder 260. The amount of data stored in media buffer 250 of switching destination terminal 200 is then constant at L.

Here, media buffer 250 of switching destination terminal 200a increases from time Tr at speed 1/β, and reaches L at time T2. The time from time Tr to T2 then becomes L×β. On the other hand, media buffer 160 of switching source terminal 100 is reduced from time Ti at speed 1/α, and reaches 0 at time T2. The time from time T1 to T2 then becomes M×α.

By appropriately setting transmission interval a at time Tr, time T2 and time T4 coincide. As described above, time Tr to T2 takes L×β, and from time Ti to T4 takes M×α. From this relationship, since time Tr to time Ti takes (K−(M−L))×α, an appropriate value for β becomes (1+K/L)×α. Therefore, at time Tr, by calculating the value of β as (1+K/L)×α and requesting CN 400 to carry out media transmission synchronization control using β, time T2 and time T4 are made to coincide, and the total amount of prebuffered data can be reduced to L.

As described above, according to the second aspect of this embodiment, the data transmission interval due to CN 400 is enlarged by just a fixed time from α to β, and it is therefore possible to make up for the buffer size deficit of media buffer 250 of switching destination terminal 200a. As a result, switching destination terminal 200a ends a session with switching source terminal 100 after a fixed period of time without using media buffer 160 of switching source terminal 100 and seamless terminal switching can be implemented. This means that the convenience for the user after terminal switching is substantially improved.

### Embodiment 3

Next, a terminal switching system of embodiment 3 of the present invention will be described.

The terminal switching system of this embodiment is the same as the terminal switching system of embodiment 1 with regards to the seamless terminal switching performance, and differs in the point of using the media buffer of a third party terminal in place of the media buffer of the switching source terminal. Here, “third party terminal” is a terminal other than the switching source terminal and CN, and broadly means a terminal capable of connecting with a switching destination terminal via a network capable of data transmission without being subject to the influence of network jitter.

In embodiment 1, in the event that N>(I+i)+L holds true (S1007: YES), in order to prevent media buffer 250 of switching destination terminal 200 from overflowing, switching destination terminal 200 uses media buffer 160 of switching source terminal 100 in order to hold data transmitted from CN 400. However, in particular, in the event that switching source terminal 100 is battery driven etc., it is not preferable to give a processing load to switching source terminal 100.

With the seamless terminal switching system of this embodiment, in order to improve the convenience of this seamless terminal switching, a media buffer of a third party terminal other than the switching source terminal is used.

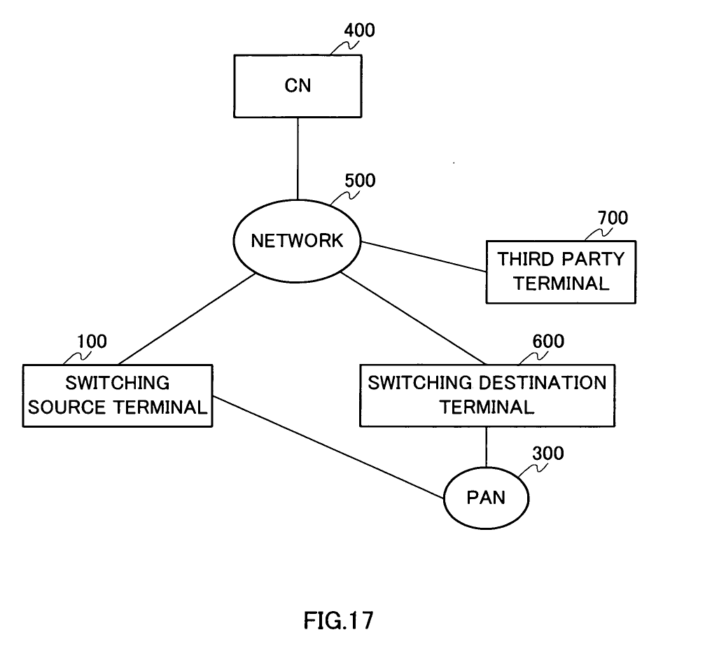

FIG. 17 is a system configuration view of a terminal switching system of embodiment 3 of the present invention. The terminal switching system of this embodiment has a basic configuration that is the same as the terminal switching system of the embodiment shown in FIG. 4, with the same structural elements being given the same numerals, and description thereof being omitted.

The terminal switching system of FIG. 17 has switching source terminal 100, CN 400, network 500 such as the Internet etc., switching destination terminal 600 that is a terminal switching target, and third party terminal 700. As with the case of embodiment 1, it is possible to use PAN (Personal Area Network) 300 as a network for between switching source terminal 100 and switching destination terminal 200.

Third party terminal 700 is capable of connecting to network 500, and by using PAN such as UWB or Bluetooth (registered trademark) etc. (not shown) to switching destination terminal 600 as network 500, it is possible to communicate without being subject to the influence of network jitter.

Further, third party terminal 700 is provided with a media buffer (not shown) for storing data. The configuration of third party terminal 700 may be, for example, the same as switching source terminal 100 shown in FIG. 11, and can be similarly understood, and a detailed description thereof is therefore omitted.

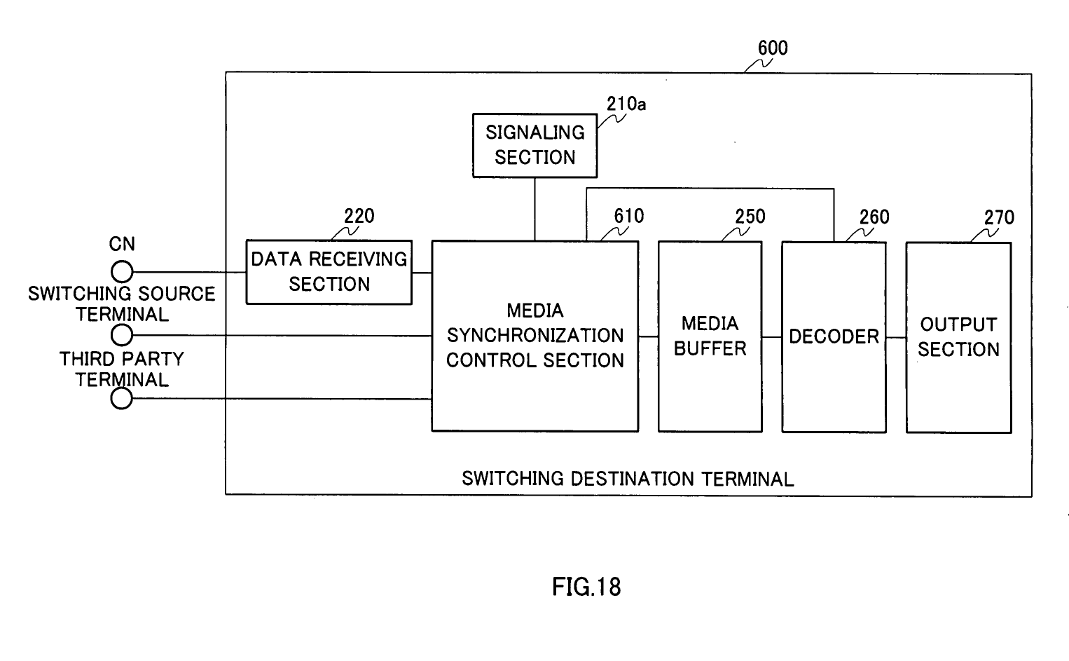

FIG. 18 is a block diagram showing an internal configuration of switching destination terminal 600 of this embodiment. In FIG. 18, structural elements of the same operation as switching destination terminal 200 of embodiment 1 are given the same numerals.

Switching destination terminal 600 has signaling section 210a controlling sessions among switching source terminal 100, CN400, and third party terminal 700, data receiving section 220 receiving data transmitted from CN 400, media synchronization control section 610 controlling storage of received data to media buffer 250, media buffer 250 storing received data, decoder 260 decoding received data, decoder 260 decoding received data, and output section 270 outputting data decoded by the decoder.

In the above configuration, media synchronization control section 610 and signaling section 210a are structural elements different from switching destination terminal 200 of embodiment 1.

Here, media synchronization control section 610 manages the amount of data stored in media buffer 250 and the data number of stored data, carries out control according to the storage amount of media buffer 250 when data is received from CN 400, and transmits data to third party terminal 700 in the event that there is no space in media buffer 250. Further, in the event that data of the newest data number to be outputted to decoder 260 does not exist in media buffer 250, and in the event that the newest data number is not a data number already transmitted to third party terminal 700, data of the newest data number is acquired from media buffer 160 of switching source terminal 100. On the other hand, in the event that the newest data number is a data number already transmitted to third party terminal 700, it is possible to maintain continuity of data numbers by acquiring the data of the newest data number from the media buffer of third party terminal 700. In addition to sessions between CN 400 and switching source terminal 100, signaling section 210a is also capable of establishing and controlling sessions with third party terminal 700.

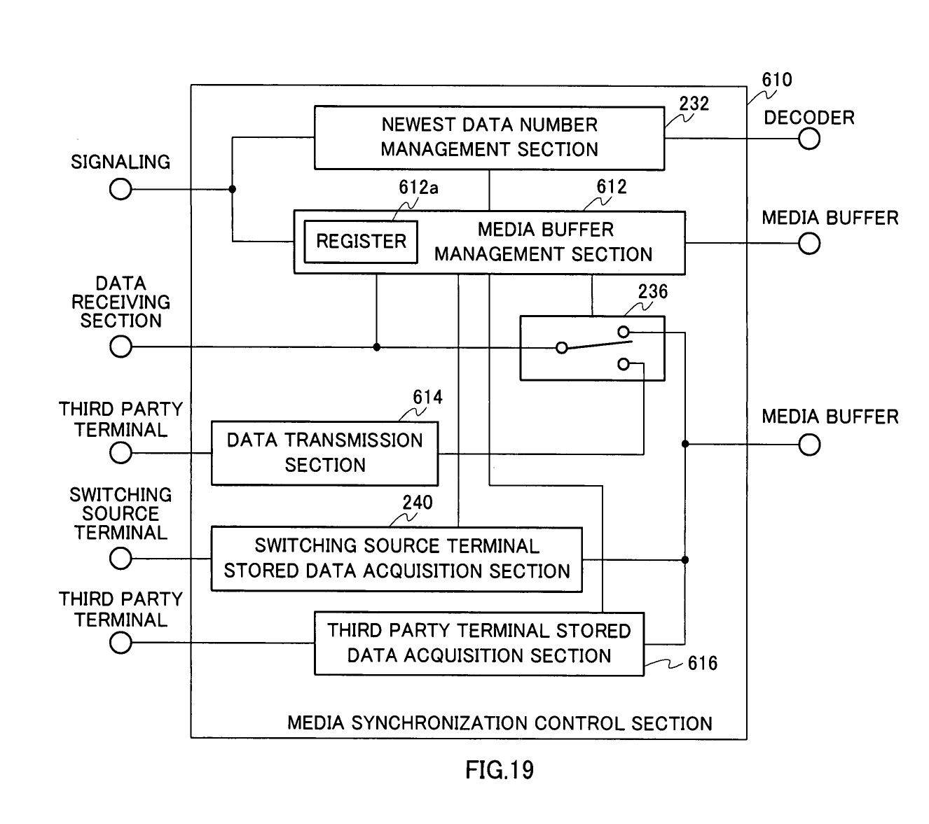

FIG. 19 is a block diagram showing an internal configuration of media synchronization control section 610. In FIG. 19, structural elements of the same operation as media synchronization control section 230 of embodiment 1 are given the same numerals.

Media synchronization control section 610 has newest data number management section 232, media buffer management section 612, switch 236, data transmission section 614, switching source terminal stored data acquisition section 240, and third party terminal stored data acquisition section 616.

Newest data number management section 232 holds newest data numbers received from signaling section 210a, increments the newest data numbers when decoder 260 acquires data from media buffer 250, and reports the updating to media buffer management section 612.

Media buffer management section 612 manages the amount of data stored in media buffer 250 and the data numbers of stored data. In the event that there is no space in media buffer 250 when data receiving section 220 receives data from CN 400, the data numbers of the received data is recorded and the corresponding received data is transmitted to data transmission section 614, and in the event that there is space in media buffer 250, the received data is written to media buffer 250.

Further, when updating of the newest data is reported from newest data number management section 232, in the event that data of the newest data number does not exist in media buffer 250, and in the event that the newest data number is a data number that has not already been transmitted to third party terminal 700, media buffer management section 612 instructs switching source terminal stored data acquisition section 240 to acquire data of the newest data number from media buffer 160 of switching source terminal 100. Further, in the event that the newest data number is a data number already transmitted to third party terminal 700, third party terminal stored data acquisition section 616 is instructed to acquire data of the newest data number from the media buffer of third party terminal 700.

Switch 236 then switches output of data received by data receiving section 220 from CN 400 to media buffer 250 or data transmission section 614 according to determination of media buffer management section 612.

In the event that there is no space in media buffer 250, data transmission section 614 transmits data transmitted from media buffer management section 612 that is data received by section 220 from CN 400 to third party terminal 700.

Switching source terminal stored data acquisition section 240 acquires data for newest data numbers from media buffer 160 of switching source terminal 100 based on newest data number data acquisition report by media buffer management section 612 and writes this data to media buffer 250.

Third party terminal stored data acquisition section 616 acquires data for newest data numbers from media buffer of third party terminal 700 based on newest data number data acquisition report by media buffer management section 612 and writes this data to media buffer 250.

In the above configuration, media buffer management section 612, data transmission section 614, and third party terminal stored data acquisition section 616 are respectively different from structural elements corresponding to media synchronization control section 230 of embodiment 1.

Specifically, media buffer management section 612 is provided internally with register 612a holding data numbers transmitted to third party terminal 700, and differs in that it is possible to determine whether the source of acquisition of data is switching source terminal 100 or third party terminal 700 by referring to the recorded data numbers. Further, data transmission section 614 differs in that the transmission destination of data is third party terminal 700 rather than switching source terminal 100.

Moreover, third party terminal stored data acquisition section 616 is a newly added structural element that has a function for acquiring data of the newest data number of the media buffer of third party terminal 700 based on data acquisition report of the newest data number using media buffer management section 612 and writing this data to media buffer 250.

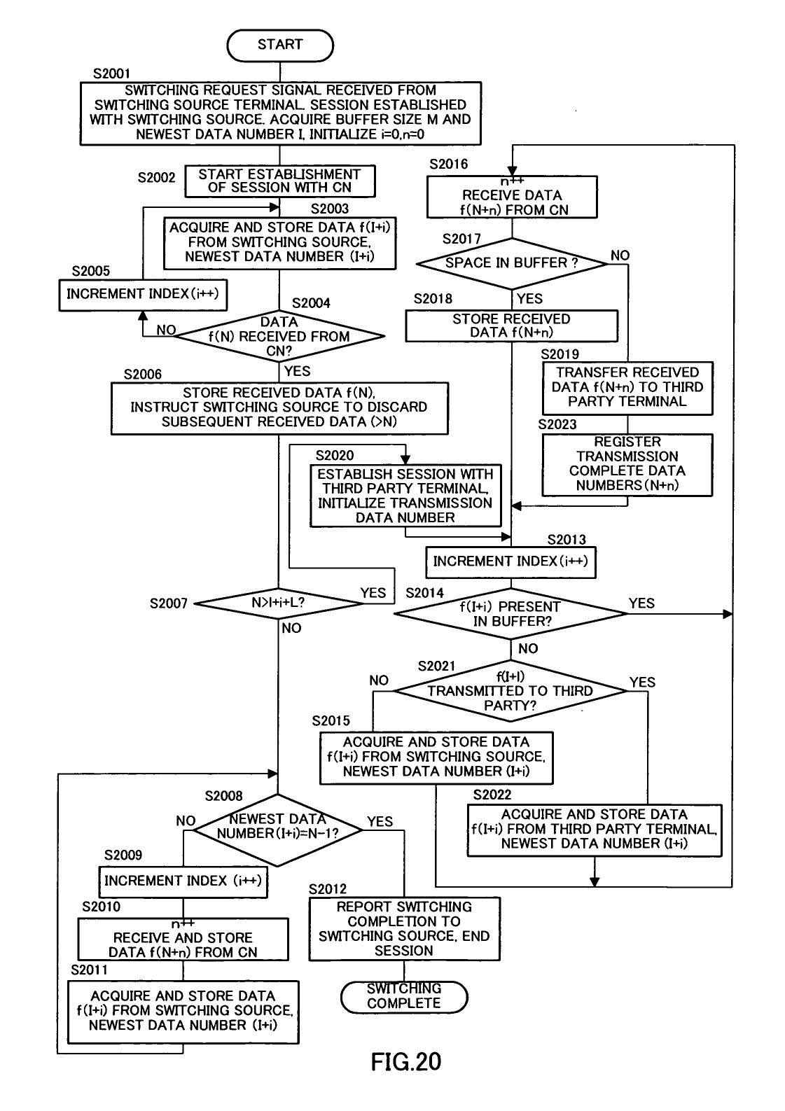

Next, the operation of switching destination terminal 600 will be described in details using FIG. 20. FIG. 20 is a flowchart illustrating the operation of switching destination terminal 600. In FIG. 20, the operation (S2001 to S2012) is exactly the same as the case in embodiment 1 shown in FIG. 8 and therefore the description thereof is omitted.

When switching destination terminal 600 receives data f (N) from CN 400, in the event that, from the relationship of newest data number (I+i), buffer size L of media buffer 250, and earliest data number N to have arrived from CN 400, N>(I+i)+L holds true (S2007: YES), media buffer management section 612 establishes a session with third party terminal 700 via signaling section 210a, and initializes register 612a for recording a data number of data which has transmitted to third party terminal 700 (S2020).

Before establishment of a session, third party terminal 700 is specified using a service detection protocol. For example, SLP (Service Location Protocol), and an SSDP (Simple Service Discovery Protocol) for UPnP (Universal Plug and Play) etc. can be used as the service discovery protocol.

Media buffer management section 612 increments index i of the newest data number to (i++) at the timing of decoder 260 acquiring the newest data from media buffer 250 (S2013), and confirms whether or not data f (I+i) of the newest data number (I+i) exists in media buffer 250 (S2014).

In the event that data f (I+i) does not exist (S2014: NO), media buffer management section 612 confirms register 612a for registering the data number of data which has transmitted to third party terminal 700 (S2021).

As a result, in the event that the newest data number (I+i) does not exist in register 612a (S2021: NO), media buffer management section 612 instructs acquisition of f(I+i) from switching source terminal 100 to switching source terminal stored data acquisition section 240. Switching source terminal stored data acquisition section 240 receives this instruction, acquires f(I+i) from media buffer 160 of switching source terminal 100, and writes this to media buffer 250 (S2015).

On the other hand, in the event that the newest data number (I+i) does exist in register 612a (S2021: YES), media buffer management section 612 instructs acquisition of f(I+i) from third party terminal 700 to third party terminal stored data acquisition section 616. Third party terminal stored data acquisition section 616 receives this instruction, acquires f(I+i) from the media buffer of third party terminal 700, and writes this to media buffer 250 (S2022).

Further, in the event that data f(I+i) exists (S2014: YES), media buffer management section 612 increments index N of data received from CN 400 to (N++) when data receiving section 220 receives the next data from CN 400 (S2016), and confirms the presence or absence of space in media buffer 250 (S2017).

At this time, in the event that space for storing data exists in media buffer 250 (S2017: YES), data f (N+n) is written to media buffer 250 (S2018).

On the other hand, in the event that space for storing data does not exist in media buffer 250 (S2017: NO), media buffer management section 612 connects the output of switch 236 to the side of data transmission section 614 and transmits data f (N+n) to data transmission section 614. Data transmission section 614 then transfers the data to third party terminal 700 (S2019). Media buffer management section 612 registers the data number (N+n) of the transferred data in internal register 612a holding the data numbers transmitted to third party terminal 700 (S2023).

Decoder 260 is then capable of acquiring data of consecutive data numbers continuously while preventing media buffer 250 from overflowing by repeating the above operation (S2013 to S2023).

In the above, a session is established with CN 400, and after data arrives from CN 400, by establishing a session between switching destination terminal 600 and third party terminal 700, media buffer management section 612 confirms the data storage state of media buffer 250, and in the event that there is no space in media buffer 250, prevents data loss due to overflow of media buffer 250 of switching destination terminal 600 by writing to media buffer of third party terminal 700.

On the other hand, in the event that data of the newest data number does not exist in media buffer 250, media buffer management section 612 refers to the data numbers which has transmitted to third party terminal 700 recorded in the internal register 612a, and ensures continuity of data numbers by acquiring data of the newest data number from media buffer 160 of switching source terminal 100 or the media buffer of third party terminal 700.

In this way, by using appropriate third party terminal 700, it is possible to rapidly end a session between switching source terminal 100 and switching destination terminal 600, and this makes it possible to implement seamless terminal switching that substantially improves convenience for a user.

In this embodiment, a mode using a media buffer of third party terminal 700 in place of media buffer 160 of switching source terminal 100 on a seamless terminal switching system of embodiment 1 is described. However, it can be easily understood by one skilled in the art to improve the seamless terminal switching system described in embodiment 2 similarly to this embodiment by using a third party terminal.

The present invention is therefore effective in implementing seamless terminal switching while ensuring continuity of media data outputted by a switching destination terminal with respect to a switching source terminal or third party terminal without increasing response delay when switching a terminal maintaining a session with a communicating party to other terminal while maintaining the session. For example, this is applicable to terminal switching technology for the case of outputting images received and played back for digital still cameras or digital video movies etc corresponding to mobile telephones and networks at display devices such as televisions etc.

It is an object of the present invention to provide seamless terminal switching technology capable of, with regards to session mobility, and in particular with regards to session mobility of streaming applications requiring prebuffer in a media buffer of a terminal, in order to implement seamless terminal switching, (1) immediately after a switching instruction, generating a prebuffer state in a media buffer of a switching destination terminal, and (2) also after establishing a session with CN, continuing to store data in a media buffer without losing continuity of data numbers.

The present invention is by no means limited to the embodiments described above, and various modifications and revisions are possible without deviating from the scope of the present invention.

What is claimed is:

1. A terminal apparatus comprising:
an establishing section establishing a streaming session with a communicating party according to a terminal switching request;
a receiving section receiving data from the communicating party after the streaming session is established with the communicating party;
a storing section storing received data; and
an acquisition section acquiring newest data from the terminal apparatus of a switching source transmitting the terminal switching request in the event that the newest data to be outputted is not in the storing section after the terminal switching request is received and the storing section starts storing the data.

2. The terminal apparatus according to claim 1, wherein the acquisition section comprises a section determining whether or not the newest data is in the storing section based on data numbers of data stored in the storing section, and, after the terminal switching request is received and the storing section starts storing the data, in the event that it is determined that the newest data is not in the storing section, acquires the newest data from the switching source terminal apparatus.

3. The terminal apparatus according to claim 1, further comprising a transmission section, in the event that there is no space in the storing section when the receiving section receives data, transmitting the received data to at least one terminal apparatus of the switching source terminal apparatus and a terminal apparatus other than the switching source terminal apparatus.

4. The terminal apparatus according to claim 3, wherein the acquisition section comprises a section determining whether or not the newest data is in the storing section based on data numbers of data stored in the storing section, and acquires the newest data from said at least one terminal apparatus in the event that the newest data is not in the storing section after the received data is transmitted to said at least one terminal apparatus.

5. The terminal apparatus according to claim 3, wherein the transmission section comprises a section determining whether or not there is space in the storing section when data is received by the receiving section based on the amount of data stored in the storing section, and, in the event that it is determined that there is no space in the storing section when data is received by the receiving section, transmits received data to said at least one terminal apparatus.

6. The terminal apparatus according to claim 5, wherein the acquisition section comprises a section determining whether or not the newest data is in the storing section based on data numbers of data stored in the storing section, and acquires the newest data from said at least one terminal apparatus in the event that it is determined that the newest data is not in the storing section after the received data is transmitted to said at least one terminal apparatus.

7. The terminal apparatus according to claim 1, further comprising a delay control section controlling the communicating party so that reception of data from said communicating party is delayed after the streaming session is established with said communicating party.

8. The terminal apparatus according to claim 7, wherein the delay control section controls the communicating party to pause data transmission for a predetermined time so that reception of data from said communicating party is delayed.

9. The terminal apparatus according to claim 7, wherein the delay control section controls the communicating party to set for a predetermined time a data transmission interval from said communicating party to the terminal apparatus larger than a transmission interval at which data is transmitted from said communicating party to the switching source terminal and larger than a transmission interval at which data is transmitted from said communicating party to the switching destination terminal immediately after terminal switching so that reception of data from said communicating party is delayed.

10. The terminal apparatus according to claim 9, wherein, after data from the communicating party starts being received and stored, at a time where data stored in the switching source terminal apparatus reduces to 0, the data transmission interval from the communicating party is set so that the amount of data stored in the storing section is full.

11. A terminal switching method comprising the steps
of:
establishing a streaming session with a communicating party according to a terminal switching request;
receiving data from the communicating party after the streaming session is established with the communicating party;
storing the received data in a storing section; and
acquiring newest data from the terminal apparatus of a switching source transmitting the terminal switching request in the event that newest data to be outputted is not in the storing section after the terminal switching request is received and the storing section starts storing the data.

12. A computer-readable storage medium storing a program for implementing each step of the terminal switching method of claim 11 on a computer.

13. A terminal apparatus comprising:
an establishing section establishing a streaming session with another terminal apparatus constituting a target of a terminal switching request;
a receiving section receiving data from said another terminal apparatus after the streaming session is established with said another terminal apparatus;
a storing section storing received data; and
a transmission section transmitting data corresponding to a newest data acquisition request from data stored in the storing section to said another terminal apparatus according to the newest data acquisition request from said another terminal apparatus.

14. A terminal switching method comprising the steps of:
establishing a streaming session with another terminal apparatus constituting a target of a terminal switching request;
receiving data from said another terminal apparatus after the streaming session is established with said another terminal apparatus;
storing the received data in a storing section; and
transmitting data corresponding to a newest data acquisition request from data stored in the storing section to said another terminal apparatus according to the newest data acquisition request from said another terminal apparatus.

15. A computer-readable storage medium storing a program for implementing each step of the terminal switching method of claim 14 on a computer.

16. A terminal switching system having a switching destination terminal apparatus and a switching source terminal apparatus, wherein:
the switching destination terminal apparatus comprises:
a first establishing section establishing a streaming session with a communicating party according to a terminal switching request transmitted by the switching source terminal apparatus;
a first receiving section receiving data from the communicating party after the streaming session is established with the communicating party;
a first storing section storing data received by the first receiving section; and
an acquisition section acquiring newest data from the switching source terminal apparatus in the event that newest data to be outputted is not in the first storing section after the terminal switching request is received and the first storing section starts storing the data; and
the switching source terminal apparatus comprises:
a second establishing section establishing a streaming session with the switching destination terminal apparatus;
a second receiving section receiving data from the switching destination terminal apparatus after the streaming session is established with the switching destination terminal apparatus;
a second storing section storing data received by the second receiving section; and
a second transmission section transmitting data corresponding to a newest data acquisition request from data stored in the second storing section to the switching destination terminal apparatus according to the newest data acquisition request from the switching destination terminal apparatus.
